(19) United States
(12) Patent Application Publication
(10) Pub. No.: US 2022/0389152 A1
(43) Pub. Date: Dec. 8, 2022

(54) FOAM LAYER WITH THERMAL BARRIER PROPERTIES

(71) Applicant: SAINT-GOBAIN PERFORMANCE PLASTICS CORPORATION, Solon, OH (US)

(72) Inventors: Fei WANG, Winchester, MA (US); Chuanping LI, Shrewsbury, MA (US); Rachel BROWN, Shrewsbury, MA (US); Roger P. ZALESKI, North Grafton, MA (US); Charles LEYDER, Paris (FR); Senthil JAYASEELAN, Mechanicville, NY (US); Arthur L. ADAM, JR., Noth Grosvenordale, CT (US); Jia LIU, Shrewsbury, MA (US); Nicholas David ORF, Natick, MA (US)

(21) Appl. No.: 17/804,127

(22) Filed: May 26, 2022

Related U.S. Application Data
(60) Provisional application No. 63/196,074, filed on Jun. 2, 2021.

(51) Int. Cl. C08G 18/77; C08G 18/08; C08G 18/22; C08G 18/38; C08G 18/48; C08G 18/63; C08G 18/79

(52) U.S. Cl. CPC C08G 18/778; C08G 18/0876; C08G 18/0885; C08G 18/222; C08G 18/3853; C08G 18/4841; C08G 18/632; C08G 18/797; C08G 2101/00

(57) ABSTRACT

The present disclosure relates to a foam layer that may include a silicone based matrix component, a flame retardant filler component, and an insulation filler component. The foam layer may have a thickness of at least about 0.5 mm and no greater than about 10 mm. The foam layer may further have a compression force deflection at 25% of at least about 5 kPa and not greater than about 500 kPa. The foam layer may also have a HBF flammability rating as measured according to ASTM D4986.

### CROSS-REFERENCE TO RELATED APPLICATION(S)

This Application claims priority under 35 U.S.C. § 119(e) to U.S. Provisional Patent Application No. 63/196,074, entitled “FOAM LAYER WITH THERMAL BARRIER PROPERTIES,” by Fei Wang et al., filed Jun. 2, 2021, which is assigned to the current assignee hereof and incorporated herein by reference in its entirety.

### FIELD OF THE DISCLOSURE

The present disclosure relates to a foam layer and, in particular, a foam layer for use as a thermal barrier in various applications, for example, in a battery pack, and methods of forming the same.

### BACKGROUND

Foam layer and/or films may be designed for high temperature protection in various applications, for example, for use as thermal barriers in electric vehicle battery packs, thermal barrier coverings in high temperature cable protection, thermal barrier containers for thermal spray containment, etc. However, in these, and in other applications, potential heat growth continues to increase due to improvements in technology. Accordingly, there is a continuing need for improved barrier designs that protect against such high heat potential.

### SUMMARY

According to a first aspect, a foam layer may include a silicone based matrix component, a flame retardant filler component, and an insulation filler component. The foam layer may have a thickness of at least about 0.5 mm and no greater than about 10 mm. The foam layer may further have a compression force deflection at 25% of at least about 5 kPa and not greater than about 500 kPa. The foam layer may also have a HBF flammability rating as measured according to ASTM D4986.

According to another aspect, a foam layer may include a silicone based matrix component, a flame retardant filler component, and an insulation filler component. The foam layer may have a thickness of at least about 0.5 mm and no greater than about 10 mm. The foam layer may further have a compression force deflection at 25% of at least about 5 kPa and not greater than about 500 kPa. The foam layer may also have a self ignition time of at least about 1 minute when exposed to a hotplate test at 650° C.

According to still another aspect, a foam layer may include a silicone based matrix component, a flame retardant filler component, and an insulation filler component. The flame retardant filler component may include a filler selected from the group consisting of metal hydrates, borate compounds, platinum compounds, transition metal oxides, metal carbonates, calcium silicates, aluminum silicates, magnesium silicates, glass frits, alkaline salts, vermiculites and any combination thereof. The insulation filler component may include a filler selected from the group consisting of expanded perlite, unexpanded perlite, glass beads, vermiculite, expanded vermiculite, expanded glass, zeolite, aerogel, silica, porous silica, porous alumina and any combination thereof. The foam layer may have a thickness of at least about 0.5 mm and no greater than about 10 mm. The foam layer may further have a compression force deflection at 25% of at least about 5 kPa and not greater than about 500 kPa.

According to another aspect, a thermal barrier composite may include a silicone based matrix component, a flame retardant filler component, and an insulation filler component. The thermal barrier composite may have a thickness of at least about 0.5 mm and no greater than about 10 mm. The thermal barrier composite may further have a compression force deflection at 25% of at least about 5 kPa and not greater than about 500 kPa. The thermal barrier composite may also have a HBF flammability rating as measured according to ASTM D4986.

According to yet another aspect, a thermal barrier composite may include a silicone based matrix component, a flame retardant filler component, and an insulation filler component. The thermal barrier composite may have a thickness of at least about 0.5 mm and no greater than about 10 mm. The thermal barrier composite may further have a compression force deflection at 25% of at least about 5 kPa and not greater than about 500 kPa. The thermal barrier composite may also have a self ignition time of at least about 1 minute when exposed to a hotplate test at 650° C.

According to still another aspect, a thermal barrier composite may include a silicone based matrix component, a flame retardant filler component, and an insulation filler component. The flame retardant filler component may include a filler selected from the group consisting of metal hydrates, borate compounds, platinum compounds, transition metal oxides, metal carbonates, calcium silicates, aluminum silicates, magnesium silicates, glass frits, alkaline salts, vermiculites and any combination thereof. The insulation filler component may include a filler selected from the group consisting of expanded perlite, unexpanded perlite, glass beads, vermiculite, expanded vermiculite, expanded glass, zeolite, aerogel, silica, porous silica, porous alumina and any combination thereof. The thermal barrier composite may have a thickness of at least about 0.5 mm and no greater than about 10 mm. The thermal barrier composite may further have a compression force deflection at 25% of at least about 5 kPa and not greater than about 500 kPa.

### BRIEF DESCRIPTION OF THE DRAWINGS

Embodiments are illustrated by way of example and are not limited to the accompanying figures.

FIG. 1 includes an illustration of an example foam layer according to certain embodiments described herein; and

FIG. 2 includes an illustration of an example thermal barrier composite according to certain embodiments described herein.

Skilled artisans appreciate that elements in the figures are illustrated for simplicity and clarity and have not necessarily been drawn to scale.

### DETAILED DESCRIPTION

The following discussion will focus on specific implementations and embodiments of the teachings. The detailed description is provided to assist in describing certain embodiments and should not be interpreted as a limitation on the scope or applicability of the disclosure or teachings. It will be appreciated that other embodiments can be used based on the disclosure and teachings as provided herein.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single item is described herein, more than one item may be used in place of a single item. Similarly, where more than one item is described herein, a single item may be substituted for that more than one item.

Embodiments described herein are generally directed to a foam layer that may include a silicone based matrix component, a flame retardant filler component, and an insulation filler component. According to still other embodiments, the foam layer may demonstrate a combination of improved performance in flame resistance and compression.

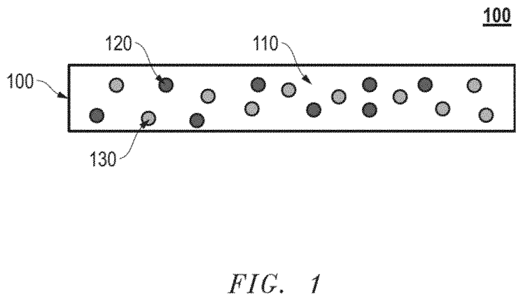

For purposes of illustration, FIG. 1 shows a foam layer 100 according to embodiments described herein. As shown in FIG. 1, a foam layer 100 may include a silicone based matrix component 110, a flame retardant filler component 120, and an insulation filler component 130.

According to particular embodiments, the silicone based matrix component 110 may include platinum catalyzed addition cured silicone foam. According to still other embodiments, the silicone based matrix component 110 may include peroxide cured silicone foam. According to yet other embodiments, the silicone based matrix component 110 may include tin catalyzed silicone foam. According to still other embodiments, the silicone based matrix component 110 may include any combination of a platinum catalyzed addition cured silicone foam, a peroxide cured silicone foam, and a tin catalyzed silicone foam.

According to particular embodiments, the silicone based matrix component 110 may consist of platinum catalyzed addition cured silicone foam. According to still other embodiments, the silicone based matrix component 110 may consist of peroxide cured silicone foam. According to yet other embodiments, the silicone based matrix component 110 may consist of tin catalyzed silicone foam. According to still other embodiments, the silicone based matrix component 110 may consist of any combination of a platinum catalyzed addition cured silicone foam, a peroxide cured silicone foam, and a tin catalyzed silicone foam.

According to particular embodiments, the silicone based matrix component 110 may be a platinum catalyzed addition cured silicone foam layer. According to still other embodiments, the silicone based matrix component 110 may be a peroxide cured silicone foam layer. According to yet other embodiments, the silicone based matrix component 110 may be a tin catalyzed silicone foam layer. According to still other embodiments, the silicone based matrix component 110 may be a layer of any combination of platinum catalyzed addition cured silicone foam, a peroxide cured silicone foam, and a tin catalyzed silicone foam.

According to yet other embodiments, the flame retardant filler component 120 may be selected from a particular group of materials. For example, the flame retardant filler component 120 may be selected from the group consisting of metal hydrates, borate compounds, platinum compounds, transition metal oxides, metal carbonates, calcium silicates, aluminum silicates, magnesium silicates, glass frits, alkaline salts, vermiculites and any combination thereof.

According to still other embodiments, the flame retardant filler component 120 may include a particular material. For example, the flame retardant filler component 120 may include metal hydrates. According to still other embodiments, the flame retardant filler component 120 may include borate compounds. According to still other embodiments, the flame retardant filler component 120 may include platinum compounds. According to still other embodiments, the flame retardant filler component 120 may include transition metal oxides. According to other embodiments, the flame retardant filler component 120 may include metal carbonates. According to still other embodiments, the flame retardant filler component 120 may include calcium silicates. According to yet other embodiments, the flame retardant filler component 120 may include aluminum silicates. According to yet other embodiments, the flame retardant filler component 120 may include magnesium silicates. According to still other embodiments, the flame retardant filler component 120 may include glass frits. According to still other embodiments, the flame retardant filler component 120 may include alkaline salts. According to yet other embodiments, the flame retardant filler component 120 may include vermiculites. According to still other embodiments, the flame retardant filler component 120 may include any combination of metal hydrates, borate compounds, platinum compounds, transition metal oxides, metal carbonates, calcium silicates, aluminum silicates, magnesium silicates, glass frits, alkaline salts, or vermiculites.

According to still other embodiments, the flame retardant filler component 120 may consist of a particular material. For example, the flame retardant filler component 120 may consist of metal hydrates. According to still other embodiments, the flame retardant filler component 120 may consist of borate compounds. According to still other embodiments, the flame retardant filler component 120 may consist of platinum compounds. According to still other embodiments, the flame retardant filler component 120 may consist of transition metal oxides. According to other embodiments, the flame retardant filler component 120 may consist of metal carbonates. According to still other embodiments, the flame retardant filler component 120 may consist of calcium silicates. According to yet other embodiments, the flame retardant filler component 120 may consist of aluminum silicates. According to yet other embodiments, the flame retardant filler component 120 may consist of magnesium silicates. According to still other embodiments, the flame retardant filler component 120 may consist of glass frits. According to still other embodiments, the flame retardant filler component 120 may consist of alkaline salts. According to yet other embodiments, the flame retardant filler component 120 may consist of vermiculites. According to still other embodiments, the flame retardant filler component 120 may consist of any combination of metal hydrates, borate compounds, platinum compounds, transition metal oxides, metal carbonates, calcium silicates, aluminum silicates, magnesium silicates, glass frits, alkaline salts, or vermiculites.

According to still other embodiments, the flame retardant filler component 120 may be a particular material. For example, the flame retardant filler component 120 may be a metal hydrate filler. According to still other embodiments, the flame retardant filler component 120 may be a borate salt filler. According to still other embodiments, the flame retardant filler component 120 may be a platinum compound filler. According to still other embodiments, the flame retardant filler component 120 may be a transition metal oxide filler. According to other embodiments, the flame retardant filler component 120 may be a metal carbonate filler. According to still other embodiments, the flame retardant filler component 120 may be a calcium silicate filler. According to yet other embodiments, the flame retardant filler component 120 may be an aluminum silicate filler. According to yet other embodiments, the flame retardant filler component 120 may be a magnesium silicate filler. According to still other embodiments, the flame retardant filler component 120 may be a glass frit filler. According to still other embodiments, the flame retardant filler component 120 may be an alkaline salt filler. According to yet other embodiments, the flame retardant filler component 120 may be a vermiculite filler. According to still other embodiments, the flame retardant filler component 120 may be a filler of any combination of metal hydrates, borate compounds, platinum compounds, transition metal oxides, metal carbonates, calcium silicates, aluminum silicates, magnesium silicates, glass frits, alkaline salts, or vermiculites.

According to still other embodiments, the flame retardant filler component 120 may be selected from a particular group of metal hydrate materials. For example, the flame retardant filler component 120 may be selected from a group consisting of aluminum trihydrate, magnesium dihydroxides, boehmite, calcium hydroxide, Huntite, gypsum, hydromagnesite and any combination thereof.

According to still other embodiments, the flame retardant filler component 120 may include a particular metal hydrate material. For example, the flame retardant filler component 120 may include aluminum trihydrate. According to still other embodiments, the flame retardant filler component 120 may include magnesium dihydroxides. According to yet other embodiments, the flame retardant filler component 120 may include boehmite. According to other embodiments, the flame retardant filler component 120 may include calcium hydroxide. According to still other embodiments, the flame retardant filler component 120 may include Huntite. According to yet other embodiments, the flame retardant filler component 120 may include gypsum. According to other embodiments, the flame retardant filler component 120 may include hydromagnesite. According to still other embodiments, the flame retardant filler component 120 may include any combination of aluminum trihydrate, magnesium dihydroxides, boehmite, calcium hydroxide, Huntite, gypsum, or hydromagnesite.

According to still other embodiments, the flame retardant filler component 120 may consist of a particular metal hydrate material. For example, the flame retardant filler component 120 may consist of aluminum trihydrate. According to still other embodiments, the flame retardant filler component 120 may consist of magnesium dihydroxides. According to yet other embodiments, the flame retardant filler component 120 may consist of boehmite. According to other embodiments, the flame retardant filler component 120 may consist of calcium hydroxide. According to still other embodiments, the flame retardant filler component 120 may consist of Huntite. According to yet other embodiments, the flame retardant filler component 120 may consist of gypsum. According to other embodiments, the flame retardant filler component 120 may consist of hydromagnesite. According to still other embodiments, the flame retardant filler component 120 may consist of any combination of aluminum trihydrate, magnesium dihydroxides, boehmite, calcium hydroxide, Huntite, gypsum, or hydromagnesite.

According to still other embodiments, the flame retardant filler component 120 may be a particular metal hydrate material filler. For example, the flame retardant filler component 120 may be an aluminum trihydrate filler. According to still other embodiments, the flame retardant filler component 120 may be a magnesium dihydroxide filler. According to yet other embodiments, the flame retardant filler component 120 may be a boehmite filler. According to other embodiments, the flame retardant filler component 120 may be a calcium hydroxide filler. According to still other embodiments, the flame retardant filler component 120 may be a Huntite filler. According to yet other embodiments, the flame retardant filler component 120 may be a gypsum filler. According to other embodiments, the flame retardant filler component 120 may be a hydromagnesite filler. According to still other embodiments, the flame retardant filler component 120 may be a filler of any combination of aluminum trihydrate, magnesium dihydroxides, boehmite, calcium hydroxide, Huntite, gypsum, or hydromagnesite.

According to still other embodiments, the flame retardant filler component 120 may be selected from a particular group of borate salt materials. For example, the flame retardant filler component 120 may be selected from a group consisting of zinc borate, calcium borate, sodium borate, potassium borate, lithium borate and any combination thereof.

According to still other embodiments, the flame retardant filler component 120 may include a particular borate salt material. For example, the flame retardant filler component 120 may include zinc borate. According to yet other embodiments, the flame retardant filler component 120 may include calcium borate. According to other embodiments, the flame retardant filler component 120 may include sodium borate. According to still other embodiments, the flame retardant filler component 120 may include potassium borate. According to yet other embodiments, the flame retardant filler component 120 may include lithium borate. According to still other embodiments, the flame retardant filler component 120 may include any combination of zinc borate, calcium borate, sodium borate, potassium borate, or lithium borate.

According to still other embodiments, the flame retardant filler component 120 may consist of a particular borate salt material. For example, the flame retardant filler component 120 may consist of zinc borate. According to yet other embodiments, the flame retardant filler component 120 may consist of calcium borate. According to other embodiments, the flame retardant filler component 120 may consist of sodium borate. According to still other embodiments, the flame retardant filler component 120 may consist of potassium borate. According to yet other embodiments, the flame retardant filler component 120 may consist of lithium borate. According to still other embodiments, the flame retardant filler component 120 may consist of any combination of zinc borate, calcium borate, sodium borate, potassium borate, or lithium borate.

According to still other embodiments, the flame retardant filler component 120 may be a particular borate salt material filler. For example, the flame retardant filler component 120 may be a zinc borate filler. According to yet other embodiments, the flame retardant filler component 120 may be a calcium borate filler. According to other embodiments, the flame retardant filler component 120 may be a sodium borate filler. According to still other embodiments, the flame retardant filler component 120 may be a potassium borate filler. According to yet other embodiments, the flame retardant filler component 120 may be a lithium borate filler. According to still other embodiments, the flame retardant filler component 120 may be a filler of any combination of zinc borate, calcium borate, sodium borate, potassium borate, or lithium borate.

According to still other embodiments, the flame retardant filler component 120 may be selected from a particular group of platinum compound materials. For example, the flame retardant filler component 120 may be selected from a group consisting of platinum-1,3-divinyl-1,1,3,3-tetramethyldisiloxane, hexachloroplatinic acid and any combination thereof.

According to still other embodiments, the flame retardant filler component 120 may include a particular of platinum compound material. For example, the flame retardant filler component 120 may include platinum-1,3-divinyl-1,1,3,3-tetramethyldisiloxane. According to yet other embodiments, the flame retardant filler component 120 may include hexachloroplatinic acid. According to still other embodiments, the flame retardant filler component 120 may include any combination of platinum-1,3-divinyl-1,1,3,3-tetramethyldisiloxane, and hexachloroplatinic acid.

According to still other embodiments, the flame retardant filler component 120 may consist of a particular of platinum compound material. For example, the flame retardant filler component 120 may consist of platinum-1,3-divinyl-1,1,3,3-tetramethyldisiloxane. According to yet other embodiments, the flame retardant filler component 120 may consist of hexachloroplatinic acid. According to still other embodiments, the flame retardant filler component 120 may consist of any combination of platinum-1,3-divinyl-1,1,3,3-tetramethyldisiloxane, and hexachloroplatinic acid.

According to still other embodiments, the flame retardant filler component 120 may be a particular platinum compound material filler. For example, the flame retardant filler component 120 may be a platinum-1,3-divinyl-1,1,3,3-tetramethyldisiloxane filler. According to yet other embodiments, the flame retardant filler component 120 may be a hexachloroplatinic acid filler. According to still other embodiments, the flame retardant filler component 120 may be a filler or any combination of platinum-1,3-divinyl-1,1,3,3-tetramethyldisiloxane, and hexachloroplatinic acid.

According to still other embodiments, the flame retardant filler component 120 may be selected from a particular group of transition metal oxide materials. For example, the flame retardant filler component 120 may be selected from a group consisting of iron oxide, cerium oxide, titanium oxide, zinc oxide and any combination thereof.

According to still other embodiments, the flame retardant filler component 120 may include a particular transition metal oxide material. For example, the flame retardant filler component 120 may include iron oxide. According to yet other embodiments, the flame retardant filler component 120 may include cerium oxide. According to other embodiments, the flame retardant filler component 120 may include zinc oxide. According to still other embodiments, the flame retardant filler component 120 may include any combination of iron oxide, cerium oxide, titanium oxide, or zinc oxide.

According to still other embodiments, the flame retardant filler component 120 may consist of a particular transition metal oxide material. For example, the flame retardant filler component 120 may consist of iron oxide. According to yet other embodiments, the flame retardant filler component 120 may consist of cerium oxide. According to other embodiments, the flame retardant filler component 120 may consist of zinc oxide. According to still other embodiments, the flame retardant filler component 120 may consist of any combination of iron oxide, cerium oxide, titanium oxide, or zinc oxide.

According to still other embodiments, the flame retardant filler component 120 may be a particular transition metal oxide material filler. For example, the flame retardant filler component 120 may be an iron oxide filler. According to yet other embodiments, the flame retardant filler component 120 may be a cerium oxide filler. According to other embodiments, the flame retardant filler component 120 may be a zinc oxide filler. According to still other embodiments, the flame retardant filler component 120 may be a filler of any combination of iron oxide, cerium oxide, titanium oxide, or zinc oxide.

According to still other embodiments, the flame retardant filler component 120 may be selected from a particular group of metal carbonate materials. For example, the flame retardant filler component 120 may be selected from a group consisting of Huntite, calcium carbonate and any combination thereof.

According to still other embodiments, the flame retardant filler component 120 may include a particular transition metal carbonate material. For example, the flame retardant filler component 120 may include Huntite. According to yet other embodiments, the flame retardant filler component 120 may include calcium carbonate. According to still other embodiments, the flame retardant filler component 120 may include any combination of Huntite, or calcium carbonate.

According to still other embodiments, the flame retardant filler component 120 may consist of a particular transition metal carbonate material. For example, the flame retardant filler component 120 may consist of Huntite. According to yet other embodiments, the flame retardant filler component 120 may consist of calcium carbonate. According to still other embodiments, the flame retardant filler component 120 may consist of any combination of Huntite, or calcium carbonate.

According to still other embodiments, the flame retardant filler component 120 may be a particular transition metal carbonate material filler. For example, the flame retardant filler component 120 may be a Huntite filler. According to yet other embodiments, the flame retardant filler component 120 may be a calcium carbonate filler. According to still other embodiments, the flame retardant filler component 120 may be a filler of any combination of Huntite, or calcium carbonate.

According to still other embodiments, the flame retardant filler component 120 may be selected from a particular group of metal carbonate mixtures. For example, the flame retardant filler component 120 may be selected from a group consisting of a natural mixture of hydromagnesite and Huntite, synthetic magnesium carbonate hydroxide pentahydrate and any combination thereof.

According to still other embodiments, the flame retardant filler component 120 may include a particular metal carbonate mixtures. For example, the flame retardant filler component 120 may include a natural mixture of hydromagnesite. According to other embodiments, the flame retardant filler component 120 may include a natural mixture of hydromagnesite. According to still other embodiments, the flame retardant filler component 120 may include any combination of a natural mixture of hydromagnesite and Huntite, or synthetic magnesium carbonate hydroxide pentahydrate.

According to still other embodiments, the flame retardant filler component 120 may consist of a particular metal carbonate mixtures. For example, the flame retardant filler component 120 may consist of a natural mixture of hydromagnesite. According to other embodiments, the flame retardant filler component 120 may consist of a natural mixture of hydromagnesite. According to still other embodiments, the flame retardant filler component 120 may consist of any combination of a natural mixture of hydromagnesite and Huntite, or synthetic magnesium carbonate hydroxide pentahydrate.

According to still other embodiments, the flame retardant filler component 120 may be a particular metal carbonate mixture filler. For example, the flame retardant filler component 120 may be a natural mixture of hydromagnesite. According to other embodiments, the flame retardant filler component 120 may be a filler of a natural mixture of hydromagnesite. According to still other embodiments, the flame retardant filler component 120 may be a filler of any combination of a natural mixture of hydromagnesite and Huntite, or synthetic magnesium carbonate hydroxide pentahydrate.

According to still other embodiments, the flame retardant filler component 120 may be selected from a particular group of alumina silicate materials or magnesium silicate materials. For example, the flame retardant filler component 120 may be selected from a group consisting of wallastonite, mica, clay, kaolin, talc, vermiculite and any combination thereof.

According to still other embodiments, the flame retardant filler component 120 may include a particular alumina silicate material or magnesium silicate material. For example, the flame retardant filler component 120 may include wallastonite. According to yet other embodiments, the flame retardant filler component 120 may include mica. According to still other embodiments, the flame retardant filler component 120 may include clay. According to other embodiments, the flame retardant filler component 120 may include kaolin. According to yet other embodiments, the flame retardant filler component 120 may include a talc. According to other embodiments, the flame retardant filler component 120 may include vermiculite. According to still other embodiments, the flame retardant filler component 120 may include any combination of wallastonite, mica, clay, kaolin, talc, or vermiculite.

According to still other embodiments, the flame retardant filler component 120 may consist of a particular alumina silicate material or magnesium silicate material. For example, the flame retardant filler component 120 may consist of wallastonite. According to yet other embodiments, the flame retardant filler component 120 may consist of mica. According to still other embodiments, the flame retardant filler component 120 may consist of clay. According to other embodiments, the flame retardant filler component 120 may consist of kaolin. According to yet other embodiments, the flame retardant filler component 120 may consist of talc. According to other embodiments, the flame retardant filler component 120 may consist of vermiculite. According to still other embodiments, the flame retardant filler component 120 may consist of any combination of wallastonite, mica, clay, kaolin, talc, or vermiculite.

According to still other embodiments, the flame retardant filler component 120 may be a filler of a particular alumina silicate material or magnesium silicate material. For example, the flame retardant filler component 120 may be a wallastonite filler. According to yet other embodiments, the flame retardant filler component 120 may be a mica filler. According to still other embodiments, the flame retardant filler component 120 may be a clay layer. According to other embodiments, the flame retardant filler component 120 may be a kaolin filler. According to yet other embodiments, the flame retardant filler component 120 may be a talc filler. According to other embodiments, the flame retardant filler component 120 may be a vermiculite filler. According to still other embodiments, the flame retardant filler component 120 may be a filler of any combination of wallastonite, mica, clay, kaolin, talc, or vermiculite.

According to still other embodiments, the flame retardant filler component 120 may be selected from a particular group of alkaline salt materials. For example, the flame retardant filler component 120 may be selected from a group consisting of sodium carbonate, potassium carbonate and any combination thereof.

According to still other embodiments, the flame retardant filler component 120 may include a particular alkaline salt material. For example, the flame retardant filler component 120 may include sodium carbonate. According to yet other embodiments, the flame retardant filler component 120 may include potassium carbonate. According to still other embodiments, the flame retardant filler component 120 may include any combination of sodium carbonate, or potassium carbonate.

According to still other embodiments, the flame retardant filler component 120 may consist of a particular alkaline salt material. For example, the flame retardant filler component 120 may consist of sodium carbonate. According to yet other embodiments, the flame retardant filler component 120 may consist of potassium carbonate. According to still other embodiments, the flame retardant filler component 120 may consist of any combination of sodium carbonate, or potassium carbonate.

According to still other embodiments, the flame retardant filler component 120 may be a particular alkaline salt material filler. For example, the flame retardant filler component 120 may be a sodium carbonate filler. According to yet other embodiments, the flame retardant filler component 120 may be a potassium carbonate filler. According to still other embodiments, the flame retardant filler component 120 may be filler of any combination of sodium carbonate, or potassium carbonate.

According to still other embodiments, the insulation filler component 130 may be selected from a particular group of materials. For example, the insulation filler component 130 may be selected from a group consisting of expanded perlite, unexpanded perlite, glass beads, vermiculite, expanded vermiculite, expanded glass, zeolite, aerogel, silica, porous silica, porous alumina and any combination thereof.

According to still other embodiments, the insulation filler component 130 may include a particular material. For example, the insulation filler component 130 may include expanded perlite. According to yet other embodiments, the insulation filler component 130 may include unexpanded perlite. According to yet other embodiments, the insulation filler component 130 may include glass beads. According to yet other embodiments, the insulation filler component 130 may include vermiculite. According to yet other embodiments, the insulation filler component 130 may include expanded vermiculite. According to yet other embodiments, the insulation filler component 130 may include expanded glass. According to yet other embodiments, the insulation filler component 130 may include zeolite. According to still other embodiments, the insulation filler component 130 may include aerogel. According to yet other embodiments, the insulation filler component 130 may include silica. According to yet other embodiments, the insulation filler component 130 may include porous silica. According to other embodiments, the insulation filler component 130 may include porous alumina. According to still other embodiments, the insulation filler component 130 may include any combination of expanded perlite, unexpanded perlite, glass beads, vermiculite, expanded vermiculite, expanded glass, zeolite, aerogel, silica, porous silica, or porous alumina.

According to still other embodiments, the insulation filler component 130 may consist of a particular material. For example, the insulation filler component 130 may consist of expanded perlite. According to yet other embodiments, the insulation filler component 130 may consist of unexpanded perlite. According to yet other embodiments, the insulation filler component 130 may consist of glass beads. According to yet other embodiments, the insulation filler component 130 may consist of vermiculite. According to yet other embodiments, the insulation filler component 130 may consist of expanded vermiculite. According to yet other embodiments, the insulation filler component 130 may consist of expanded glass. According to yet other embodiments, the insulation filler component 130 may consist of zeolite. According to still other embodiments, the insulation filler component 130 may consist of aerogel. According to yet other embodiments, the insulation filler component 130 may consist of silica. According to yet other embodiments, the insulation filler component 130 may consist of porous silica. According to other embodiments, the insulation filler component 130 may consist of porous alumina. According to still other embodiments, the insulation filler component 130 may consist of any combination of expanded perlite, unexpanded perlite, glass beads, vermiculite, expanded vermiculite, expanded glass, zeolite, aerogel, silica, porous silica, or porous alumina.

According to still other embodiments, the insulation filler component 130 may be a filler of a particular material. For example, the insulation filler component 130 may be an expanded perlite filler. According to yet other embodiments, the insulation filler component 130 may be an unexpanded perlite filler. According to yet other embodiments, the insulation filler component 130 may be a glass beads filler. According to yet other embodiments, the insulation filler component 130 may be a vermiculite filler. According to yet other embodiments, the insulation filler component 130 may be an expanded vermiculite filler. According to yet other embodiments, the insulation filler component 130 may be an expanded glass filler. According to yet other embodiments, the flame retardant filler component 220 may be a zeolite filler. According to still other embodiments, the insulation filler component 130 may be an aerogel filler. According to yet other embodiments, the insulation filler component 130 may be a silica filler. According to yet other embodiments, the insulation filler component 130 may be a porous silica filler. According to other embodiments, the insulation filler component 130 may be an porous alumina filler. According to still other embodiments, the insulation filler component 130 may be a filler of any combination of expanded perlite, unexpanded perlite, glass beads, vermiculite, expanded vermiculite, expanded glass, zeolite, aerogel, silica, porous silica, or porous alumina.

According to certain embodiments, the foam layer 100 may include a particular content of the silicone based matrix component 110. For example, the foam layer 100 may include a silicone based matrix component content of at least about 20 wt. % for a total weight of the foam layer, such as, at least about 25 wt. % or at least about 30 wt. % or at least about 35 wt. % or at least about 40 wt. % or at least about 45 wt. % or even at least about 50 wt. %. According to yet other embodiments, the foam layer 100 may include a silicone based matrix component content of not greater than about 85 wt. % for a total weight of the foam layer, such as, not greater than about 80 wt. % or not greater than about 75 wt. % or not greater than about 70 wt. % or even not greater than about 65 wt. %. It will be appreciated that the silicone based matrix component content of the foam layer 100 may be within a range between any of the values noted above. It will be further appreciated that the silicone based matrix component content of the foam layer 100 may be any value between any of the minimum and maximum values noted above.

According to still other embodiments, the foam layer 100 may include a particular content of flame retardant filler component 120. For example, the foam layer 100 may include a flame retardant filler component content of at least about 1 wt. % for a total weight of the foam layer 100, such as, at least about 2 wt. % or at least about 3 wt. % or at least about 4 wt. % or at least about 5 wt. % or at least about 7 wt. % or at least about 10 wt. % or at least about 12 wt. % or even at least about 15.%. According to yet other embodiments, the foam layer 100 may include a flame retardant filler component content of not greater than about 35 wt. % for a total weight of the foam layer 100, such as, not greater than about 34 wt. % or not greater than about 33 wt. % or not greater than about 32 wt. % or not greater than about 31 wt. % or not greater than about 30 wt. % or not greater than about 28 wt. % or not greater than about 25 wt. % or not greater than about 23 wt. % or not great than about 20 wt. %. It will be appreciated that the flame retardant filler component content of the foam layer 100 may be within a range between any of the values noted above. It will be further appreciated that the flame retardant filler component content of the foam layer 100 may be any value between any of the minimum and maximum values noted above.

According to still other embodiments, the foam layer 100 may include a particular content of insulation filler component 120. For example, the foam layer 100 may include an insulation filler component content of at least about 1 wt. % for a total weight of the foam layer 100, such as, at least about 2 wt. % or at least about 3 wt. % or at least about 4 wt. % or at least about 5 wt. % or at least about 7 wt. % or at least about 10 wt. % or at least about 12 wt. % or even at least about 15.%. According to yet other embodiments, the foam layer 100 may include an insulation filler component content of not greater than about 25 wt. % for a total weight of the foam layer 100, such as, not greater than about 24 wt. % or not greater than about 23 wt. % or not greater than about 22 wt. % or not greater than about 21 wt. % or not greater than about 20 wt. % or not greater than about 19 wt. % or not greater than about 18 wt. % or not greater than about 17 wt. % or not great than about 16 wt. %. It will be appreciated that the insulation filler component content of the foam layer 100 may be within a range between any of the values noted above. It will be further appreciated that the insulation filler component content of the foam layer 100 may be any value between any of the minimum and maximum values noted above.

According to certain embodiments, the foam layer 100 may have a particular flammability rating as measured according to ASTM D4986. In particular, the foam layer may have a HBF flammability rating as measured according to ASTM D4986.

According to certain embodiments, the foam layer 100 may have a particular flammability rating as measured according to ASTM D3801. In particular, the foam layer may have a V-0 flammability rating as measured according to ASTM D3801

According to yet other embodiments, the foam layer 100 may have a particular self-ignition time when exposed to a hot plate test at a temperature of 650° C. For purposes of embodiments described herein, the hot plate test is carried out by preparing a 1-inch by 1-inch specimen of the material, which is put on top of a hot plate. Then a thermal couple is fixed in a steel weight (1 inch in diameter, 2 inches in height) is put on top of the specimen to measure the cold side surface temperature. The temperature curve is recorded and the point, if any, of self-ignition is recorded. According to particular embodiments, the foam layer 100 may have a self ignition time of at least about 1 minute, such as, at least about 1.5 minutes or at least about 2 minutes or at least about 2.5 minutes or at least about 3 minutes or at least about 3.5 minutes or at least about 4.0 minutes or at least about 4.5 minutes or even at least about 5.0 minutes. It will be appreciated that the self ignition time of the foam layer 100 may be within a range between any of the values noted above. It will be further appreciated that the self-ignition time of the foam layer 100 may be any value between any of the values noted above.

According to still other embodiments, the foam layer 100 may have a particular cold-side temperature as measured at 5 minutes when a 3 mm thickness of the foam is exposed to a hot plate test at 650° C. For purposes of embodiments described herein, the hot plate test is carried out by preparing a 1 inch by 1 inch specimen of the material, which is put on top of a hot plate. Then a thermal couple is fixed in a steel weight (1 inch in diameter, 2 inches in height) is put on top of the specimen to measure the cold side surface temperature. According to certain embodiments, the foam layer 100 may have a cold side temperature of not greater than about 300° C., such as, not greater than about 275° C. or not greater than about 250° C. or not greater than about 225° C. or not greater than about 200° C. or not greater than about 175° C. or even not greater than about 150° C. According to still other embodiments, the foam layer 100 may have a cold side temperature of at least about 25° C. It will be appreciated that the cold side temperature of the foam layer 100 may be within a range between any of the values noted above. It will be further appreciated that the cold side temperature of the foam layer 100 may be any value between any of the values noted above.

According to yet other embodiments, the foam layer 100 may have a particular thickness. For example, the foam layer 100 may have a thickness of at least about 0.5 mm, such as, at least about 1.0 mm or at least about 1.5 mm or at least about 2.0 mm or at least about 2.5 mm or at least about 3.0 mm or at least about 3.5 mm or at least about 4.0 mm or at least about 4.5 mm or even at least about 5.0 mm. According to still other embodiments, the foam layer 100 may have a thickness of not greater than about 10 mm, such as, not greater than about 9.5 mm or not greater than about 9.0 mm or not greater than about 8.5 mm or not greater than about 8.0 mm or not greater than about 7.5 mm or not greater than about 7.0 mm or not greater than about 6.5 mm or even not greater than about 6.0 mm. It will be appreciated that the thickness of the foam layer 100 may be within a range between any of the minimum and maximum values noted above. It will be further appreciated that the thickness of the foam layer 100 may be any value between any of the minimum and maximum values noted above.

According to yet other embodiments, the foam layer 100 may have a particular 25% strain compression rating. For purposes of embodiments described herein, the 25% strain compression rating is defined as the compression rating of a sample measure at a 25% strain and is determined by measuring the force-to-compress and compression-force-deflection of the sample at a 25% strain. Force-to-compress (FTC) is defined as the peak force (or stress) to compress the sample to a predetermined strain and compression-force-deflection (CFD) is defined as the plateau or relaxation force (or stress) retained by a sample when held at the desired strain (i.e., 25%). Measurements are made using a Texture Analyzer, which finds and records both FTC values and CFD values after a hold time of 60 seconds, a compression speed of 0.16 mm/s and a trigger force of 10 grams.

According to certain embodiments, the foam layer 100 may have a 25% strain compression rating of not greater than about 500 kPa, such as, not greater than about 475 kPa or not greater than about 450 kPa or not greater than about 425 kPa or not greater than about 400 kPa or not greater than about 375 kPa or not greater than about 350 kPa or not greater than about 325 kPa or not greater than about 300 kPa or not greater than about 275 kPa or not greater than about 250 kPa or not greater than about 225 kPa or not greater than about 200 kPa or not greater than about 175 kPa or not greater than about 150 kPa or not greater than about 125 kPa or not greater than about 100 kPa. According to still other embodiments, the foam layer 100 may have a 25% strain compression rating of at least about 5 kPa, such as, at least about 10 kPa or at least about 15 kPa or at least about 20 kPa or at least about 25 kPa. It will be appreciated that the 25% strain compression rating of the foam layer 100 may be within a range between any of the minimum and maximum values noted above. It will be further appreciated that the 50% strain compression rating of the multilayer composite 100 may be any value between any of the minimum and maximum values noted above.

According to yet other embodiments, the foam layer 100 may have a particular density. For purpose of embodiments described herein, the density of the foam layer 100 may be determined according to ASTM D1056. According to certain embodiments, the foam layer 100 may have a density of not greater than about 1200 kg/m³, such as, not great than about 1175 kg/m³ or not greater than about 1150 kg/m³ or not greater than about 1125 kg/m³ or not greater than about 1100 kg/m³ or not greater than about 1050 kg/m³ or not greater than about 1000 kg/m3 or not greater than about 950 kg/m3 or not greater than about 900 kg/m³ or not greater than about 850 kg/m³ or not greater than about 800 kg/m³ or not greater than about 750 kg/m³ or not greater than about 700 kg/m³ or even not greater than about 650 kg/m³. According to yet other embodiments, the foam layer 100 may have a density of at least about 100 kg/m³, such as, at least about 120 kg/m³ or at least about 140 kg/m³ or at least about 160 kg/m³ or at least about 180 kg/m³ or at least about 200 kg/m³ or at least about 220 kg/m³ or even at least about 240 kg/m³. It will be appreciated that the density of the foam layer 100 may be within a range between any of the minimum and maximum values noted above. It will be further appreciated that the density of the foam layer 100 may be any value between any of the minimum and maximum values noted above.

According to yet other embodiments, the foam layer 100 may have a particular thermal conductivity as measured according to ASTM C518. For example, the foam layer 100 may have a thermal conductivity of at least about 0.01 W/mK, such as, at least about 0.02 W/mK or at least about 0.03 W/mK or at least about 0.04 W/mK or even at least about 0.05 W/mK. According to still other embodiments, the foam layer 100 may have a thermal conductivity of not greater than about 0.15 W/mK, such as, not greater than about 0.14 W/mK or not greater than about 0.13 W/mK or not greater than about 0.12 W/mK or not greater than about 0.11 W/mK or not greater than about 0.10 W/mK or not greater than about 0.09 W/mK or not greater than about 0.08 W/mK or even not greater than about 0.07 W/mK. It will be appreciated that the thermal conductivity of the foam layer 100 may be within a range between any of the minimum and maximum values noted above. It will be further appreciated that the thermal conductivity of the foam layer 100 may be any value between any of the minimum and maximum values noted above.

According to certain embodiments, the foam layer described herein may be formed according to any acceptable forming process for a foam material or foam layer.

Tuning now to additional embodiments described herein, such embodiments are generally directed to a thermal barrier composite that may include a foam layer, which may include a silicone based matrix component, a flame retardant filler component, and an insulation filler component. According to still other embodiments, the foam layer may demonstrate a combination of improved performance in flame resistance and compression.

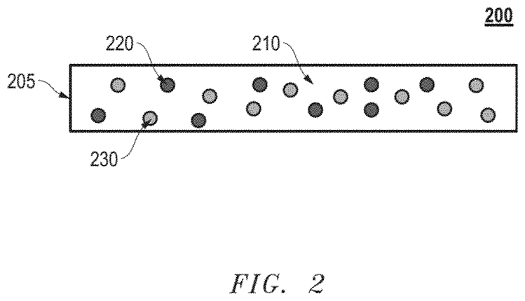

For purposes of illustration, FIG. 2 shows a thermal barrier composite 200 according to embodiments described herein. As shown in FIG. 2, a thermal barrier composite 200 may include a foam layer 205, which may include a silicone based matrix component 210, a flame retardant filler component 220, and an insulation filler component 230.

According to particular embodiments, the silicone based matrix component 210 may include platinum catalyzed addition cured silicone foam. According to still other embodiments, the silicone based matrix component 210 may include peroxide cured silicone foam. According to yet other embodiments, the silicone based matrix component 210 may include tin catalyzed silicone foam. According to still other embodiments, the silicone based matrix component 210 may include any combination of a platinum catalyzed addition cured silicone foam, a peroxide cured silicone foam, and a tin catalyzed silicone foam.

According to particular embodiments, the silicone based matrix component 210 may consist of cured silicone foam. According to still other embodiments, the silicone based matrix component 210 may consist of peroxide cured silicone foam. According to yet other embodiments, the silicone based matrix component 210 may consist of tin catalyzed silicone foam. According to still other embodiments, the silicone based matrix component 210 may consist of any combination of a platinum catalyzed addition cured silicone foam, a peroxide cured silicone foam, and a tin catalyzed silicone foam.

According to particular embodiments, the silicone based matrix component 210 may be a platinum catalyzed addition cured silicone foam layer. According to still other embodiments, the silicone based matrix component 210 may be a peroxide cured silicone foam layer. According to yet other embodiments, the silicone based matrix component 210 may be a tin catalyzed silicone foam layer. According to still other embodiments, the silicone based matrix component 210 may be a layer of any combination of a platinum catalyzed addition cured silicone foam, a peroxide cured silicone foam, and a tin catalyzed silicone foam.

According to yet other embodiments, the flame retardant filler component 220 may be selected from a particular group of materials. For example, the flame retardant filler component 220 may be selected from the group consisting of metal hydrates, borate compounds, platinum compounds, transition metal oxides, metal carbonates, calcium silicates, aluminum silicates, magnesium silicates, glass frits, alkaline salts, vermiculites and any combination thereof.

According to still other embodiments, the flame retardant filler component 220 may include a particular material. For example, the flame retardant filler component 220 may include metal hydrates. According to still other embodiments, the flame retardant filler component 220 may include borate compounds. According to still other embodiments, the flame retardant filler component 220 may include platinum compounds. According to still other embodiments, the flame retardant filler component 220 may include transition metal oxides. According to other embodiments, the flame retardant filler component 220 may include metal carbonates. According to still other embodiments, the flame retardant filler component 220 may include calcium silicates. According to yet other embodiments, the flame retardant filler component 220 may include aluminum silicates. According to yet other embodiments, the flame retardant filler component 220 may include magnesium silicates. According to still other embodiments, the flame retardant filler component 220 may include glass frits. According to still other embodiments, the flame retardant filler component 220 may include alkaline salts. According to yet other embodiments, the flame retardant filler component 220 may include vermiculites. According to still other embodiments, the flame retardant filler component 220 may include any combination of metal hydrates, borate compounds, platinum compounds, transition metal oxides, metal carbonates, calcium silicates, aluminum silicates, magnesium silicates, glass frits, alkaline salts, or vermiculites.

According to still other embodiments, the flame retardant filler component 220 may consist of a particular material. For example, the flame retardant filler component 220 may consist of metal hydrates. According to still other embodiments, the flame retardant filler component 220 may consist of borate compounds. According to still other embodiments, the flame retardant filler component 220 may consist of platinum compounds. According to still other embodiments, the flame retardant filler component 220 may consist of transition metal oxides. According to other embodiments, the flame retardant filler component 220 may consist of metal carbonates. According to still other embodiments, the flame retardant filler component 220 may consist of calcium silicates. According to yet other embodiments, the flame retardant filler component 220 may consist of aluminum silicates. According to yet other embodiments, the flame retardant filler component 220 may consist of magnesium silicates. According to still other embodiments, the flame retardant filler component 220 may consist of glass frits. According to still other embodiments, the flame retardant filler component 220 may consist of alkaline salts. According to yet other embodiments, the flame retardant filler component 220 may consist of vermiculites. According to still other embodiments, the flame retardant filler component 220 may consist of any combination of metal hydrates, borate compounds, platinum compounds, transition metal oxides, metal carbonates, calcium silicates, aluminum silicates, magnesium silicates, glass frits, alkaline salts, or vermiculites.

According to still other embodiments, the flame retardant filler component 220 may be a particular material. For example, the flame retardant filler component 220 may be a metal hydrate filler. According to still other embodiments, the flame retardant filler component 220 may be a borate salt filler. According to still other embodiments, the flame retardant filler component 220 may be a platinum compound filler. According to still other embodiments, the flame retardant filler component 220 may be a transition metal oxide filler. According to other embodiments, the flame retardant filler component 220 may be a metal carbonate filler. According to still other embodiments, the flame retardant filler component 220 may be a calcium silicate filler. According to yet other embodiments, the flame retardant filler component 220 may be an aluminum silicate filler. According to yet other embodiments, the flame retardant filler component 220 may be a magnesium silicate filler. According to still other embodiments, the flame retardant filler component 220 may be a glass frit filler. According to still other embodiments, the flame retardant filler component 220 may be an alkaline salt filler. According to yet other embodiments, the flame retardant filler component 220 may be a vermiculite filler. According to still other embodiments, the flame retardant filler component 220 may be a filler of any combination of metal hydrates, borate compounds, platinum compounds, transition metal oxides, metal carbonates, calcium silicates, aluminum silicates, magnesium silicates, glass frits, alkaline salts, or vermiculites.

According to still other embodiments, the flame retardant filler component 220 may be selected from an particular group of metal hydrate materials. For example, the flame retardant filler component 220 may be selected from a group consisting of aluminum trihydrate, magnesium dihydroxides, boehmite, calcium hydroxide, Huntite, gypsum, hydromagnesite and any combination thereof.

According to still other embodiments, the flame retardant filler component 220 may include a particular metal hydrate material. For example, the flame retardant filler component 220 may include aluminum trihydrate. According to still other embodiments, the flame retardant filler component 220 may include magnesium dihydroxides. According to yet other embodiments, the flame retardant filler component 220 may include boehmite. According to other embodiments, the flame retardant filler component 220 may include calcium hydroxide. According to still other embodiments, the flame retardant filler component 220 may include Huntite. According to yet other embodiments, the flame retardant filler component 220 may include gypsum. According to other embodiments, the flame retardant filler component 220 may include hydromagnesite. According to still other embodiments, the flame retardant filler component 220 may include any combination of aluminum trihydrate, magnesium dihydroxides, boehmite, calcium hydroxide, Huntite, gypsum, or hydromagnesite.

According to still other embodiments, the flame retardant filler component 220 may consist of a particular metal hydrate material. For example, the flame retardant filler component 220 may consist of aluminum trihydrate. According to still other embodiments, the flame retardant filler component 220 may consist of magnesium dihydroxides. According to yet other embodiments, the flame retardant filler component 220 may consist of boehmite. According to other embodiments, the flame retardant filler component 220 may consist of calcium hydroxide. According to still other embodiments, the flame retardant filler component 220 may consist of Huntite. According to yet other embodiments, the flame retardant filler component 220 may consist of gypsum. According to other embodiments, the flame retardant filler component 220 may consist of hydromagnesite. According to still other embodiments, the flame retardant filler component 220 may consist of any combination of aluminum trihydrate, magnesium dihydroxides, boehmite, calcium hydroxide, Huntite, gypsum, or hydromagnesite.

According to still other embodiments, the flame retardant filler component 220 may be a particular metal hydrate material filler. For example, the flame retardant filler component 220 may be an aluminum trihydrate filler. According to still other embodiments, the flame retardant filler component 220 may be a magnesium dihydroxide filler. According to yet other embodiments, the flame retardant filler component 220 may be a boehmite filler. According to other embodiments, the flame retardant filler component 220 may be a calcium hydroxide filler. According to still other embodiments, the flame retardant filler component 220 may be a Huntite filler. According to yet other embodiments, the flame retardant filler component 220 may be a gypsum filler. According to other embodiments, the flame retardant filler component 220 may be a hydromagnesite filler. According to still other embodiments, the flame retardant filler component 220 may be a filler of any combination of aluminum trihydrate, magnesium dihydroxides, boehmite, calcium hydroxide, Huntite, gypsum, or hydromagnesite.

According to still other embodiments, the flame retardant filler component 220 may be selected from a particular group of borate salt materials. For example, the flame retardant filler component 220 may be selected from a group consisting of zinc borate, calcium borate, sodium borate, potassium borate, lithium borate and any combination thereof.

According to still other embodiments, the flame retardant filler component 220 may include a particular borate salt material. For example, the flame retardant filler component 220 may include zinc borate. According to yet other embodiments, the flame retardant filler component 220 may include calcium borate. According to other embodiments, the flame retardant filler component 220 may include sodium borate. According to still other embodiments, the flame retardant filler component 220 may include potassium borate. According to yet other embodiments, the flame retardant filler component 220 may include lithium borate. According to still other embodiments, the flame retardant filler component 220 may include any combination of zinc borate, calcium borate, sodium borate, potassium borate, or lithium borate.

According to still other embodiments, the flame retardant filler component 220 may consist of a particular borate salt material. For example, the flame retardant filler component 220 may consist of zinc borate. According to yet other embodiments, the flame retardant filler component 220 may consist of calcium borate. According to other embodiments, the flame retardant filler component 220 may consist of sodium borate. According to still other embodiments, the flame retardant filler component 220 may consist of potassium borate. According to yet other embodiments, the flame retardant filler component 220 may consist of lithium borate. According to still other embodiments, the flame retardant filler component 220 may consist of any combination of zinc borate, calcium borate, sodium borate, potassium borate, or lithium borate.

According to still other embodiments, the flame retardant filler component 220 may be a particular borate salt material filler. For example, the flame retardant filler component 220 may be a zinc borate filler. According to yet other embodiments, the flame retardant filler component 220 may be a calcium borate filler. According to other embodiments, the flame retardant filler component 220 may be a sodium borate filler. According to still other embodiments, the flame retardant filler component 220 may be a potassium borate filler. According to yet other embodiments, the flame retardant filler component 220 may be a lithium borate filler. According to still other embodiments, the flame retardant filler component 220 may be a filler of any combination of zinc borate, calcium borate, sodium borate, potassium borate, or lithium borate.

According to still other embodiments, the flame retardant filler component 220 may be selected from a particular group of platinum compound materials. For example, the flame retardant filler component 220 may be selected from a group consisting of platinum-1,3-divinyl-1,1,3,3-tetramethyldisiloxane, hexachloroplatinic acid and any combination thereof.

According to still other embodiments, the flame retardant filler component 220 may include a particular of platinum compound material. For example, the flame retardant filler component 220 may include platinum-1,3-divinyl-1,1,3,3-tetramethyldisiloxane. According to yet other embodiments, the flame retardant filler component 220 may include hexachloroplatinic acid. According to still other embodiments, the flame retardant filler component 220 may include any combination of platinum-1,3-divinyl-1,1,3,3-tetramethyldisiloxane, and hexachloroplatinic acid.

According to still other embodiments, the flame retardant filler component 220 may consist of a particular of platinum compound material. For example, the flame retardant filler component 220 may consist of platinum-1,3-divinyl-1,1,3,3-tetramethyldisiloxane. According to yet other embodiments, the flame retardant filler component 220 may consist of hexachloroplatinic acid. According to still other embodiments, the flame retardant filler component 220 may consist of any combination of platinum-1,3-divinyl-1,1,3,3-tetramethyldisiloxane, and hexachloroplatinic acid.

According to still other embodiments, the flame retardant filler component 220 may be a particular platinum compound material filler. For example, the flame retardant filler component 220 may be a platinum-1,3-divinyl-1,1,3,3-tetramethyldisiloxane filler. According to yet other embodiments, the flame retardant filler component 220 may be a hexachloroplatinic acid filler. According to still other embodiments, the flame retardant filler component 220 may be a filler or any combination of platinum-1,3-divinyl-1,1,3,3-tetramethyldisiloxane, and hexachloroplatinic acid.

According to still other embodiments, the flame retardant filler component 220 may be selected from a particular group of transition metal oxide materials. For example, the flame retardant filler component 220 may be selected from a group consisting of iron oxide, cerium oxide, titanium oxide, zinc oxide and any combination thereof.

According to still other embodiments, the flame retardant filler component 220 may include a particular transition metal oxide material. For example, the flame retardant filler component 220 may include iron oxide. According to yet other embodiments, the flame retardant filler component 220 may include cerium oxide. According to other embodiments, the flame retardant filler component 220 may include zinc oxide. According to still other embodiments, the flame retardant filler component 220 may include any combination of iron oxide, cerium oxide, titanium oxide, or zinc oxide.

According to still other embodiments, the flame retardant filler component 220 may consist of a particular transition metal oxide material. For example, the flame retardant filler component 220 may consist of iron oxide. According to yet other embodiments, the flame retardant filler component 220 may consist of cerium oxide. According to other embodiments, the flame retardant filler component 220 may consist of zinc oxide. According to still other embodiments, the flame retardant filler component 220 may consist of any combination of iron oxide, cerium oxide, titanium oxide, or zinc oxide.

According to still other embodiments, the flame retardant filler component 220 may be a particular transition metal oxide material filler. For example, the flame retardant filler component 220 may be an iron oxide filler. According to yet other embodiments, the flame retardant filler component 220 may be a cerium oxide filler. According to other embodiments, the flame retardant filler component 220 may be a zinc oxide filler. According to still other embodiments, the flame retardant filler component 220 may be a filler of any combination of iron oxide, cerium oxide, titanium oxide, or zinc oxide.

According to still other embodiments, the flame retardant filler component 220 may be selected from a particular group of metal carbonate materials. For example, the flame retardant filler component 220 may be selected from a group consisting of Huntite, calcium carbonate and any combination thereof.

According to still other embodiments, the flame retardant filler component 220 may include a particular transition metal carbonate material. For example, the flame retardant filler component 220 may include Huntite. According to yet other embodiments, the flame retardant filler component 220 may include calcium carbonate. According to still other embodiments, the flame retardant filler component 220 may include any combination of Huntite, or calcium carbonate.

According to still other embodiments, the flame retardant filler component 220 may consist of a particular transition metal carbonate material. For example, the flame retardant filler component 220 may consist of Huntite. According to yet other embodiments, the flame retardant filler component 220 may consist of calcium carbonate. According to still other embodiments, the flame retardant filler component 220 may consist of any combination of Huntite, or calcium carbonate.

According to still other embodiments, the flame retardant filler component 220 may be a particular transition metal carbonate material filler. For example, the flame retardant filler component 220 may be a Huntite filler. According to yet other embodiments, the flame retardant filler component 220 may be a calcium carbonate filler. According to still other embodiments, the flame retardant filler component 220 may be a filler of any combination of Huntite, or calcium carbonate.

According to still other embodiments, the flame retardant filler component 220 may be selected from a particular group of metal carbonate mixtures. For example, the flame retardant filler component 220 may be selected from a group consisting of a natural mixture of hydromagnesite and Huntite, synthetic magnesium carbonate hydroxide pentahydrate and any combination thereof.

According to still other embodiments, the flame retardant filler component 220 may include a particular metal carbonate mixtures. For example, the flame retardant filler component 220 may include a natural mixture of hydromagnesite. According to other embodiments, the flame retardant filler component 220 may include a natural mixture of hydromagnesite. According to still other embodiments, the flame retardant filler component 220 may include any combination of a natural mixture of hydromagnesite and Huntite, or synthetic magnesium carbonate hydroxide pentahydrate.

According to still other embodiments, the flame retardant filler component 220 may consist of a particular metal carbonate mixtures. For example, the flame retardant filler component 220 may consist of a natural mixture of hydromagnesite. According to other embodiments, the flame retardant filler component 220 may consist of a natural mixture of hydromagnesite. According to still other embodiments, the flame retardant filler component 220 may consist of any combination of a natural mixture of hydromagnesite and Huntite, or synthetic magnesium carbonate hydroxide pentahydrate.

According to still other embodiments, the flame retardant filler component 220 may be a particular metal carbonate mixture filler. For example, the flame retardant filler component 220 may be a natural mixture of hydromagnesite. According to other embodiments, the flame retardant filler component 220 may be a filler of a natural mixture of hydromagnesite. According to still other embodiments, the flame retardant filler component 220 may be a filler of any combination of a natural mixture of hydromagnesite and Huntite, or synthetic magnesium carbonate hydroxide pentahydrate.

According to still other embodiments, the flame retardant filler component 220 may be selected from a particular group of alumina silicate materials or magnesium silicate materials. For example, the flame retardant filler component 220 may be selected from a group consisting of wallastonite, mica, clay, kaolin, talc, vermiculite and any combination thereof.

According to still other embodiments, the flame retardant filler component 220 may include a particular alumina silicate material or magnesium silicate material. For example, the flame retardant filler component 220 may include wallastonite. According to yet other embodiments, the flame retardant filler component 220 may include mica. According to still other embodiments, the flame retardant filler component 220 may include clay. According to other embodiments, the flame retardant filler component 220 may include kaolin. According to yet other embodiments, the flame retardant filler component 220 may include a talc. According to other embodiments, the flame retardant filler component 220 may include vermiculite. According to still other embodiments, the flame retardant filler component 220 may include any combination of wallastonite, mica, clay, kaolin, talc, or vermiculite.

According to still other embodiments, the flame retardant filler component 220 may consist of a particular alumina silicate material or magnesium silicate material. For example, the flame retardant filler component 220 may consist of wallastonite. According to yet other embodiments, the flame retardant filler component 220 may consist of mica. According to still other embodiments, the flame retardant filler component 220 may consist of clay. According to other embodiments, the flame retardant filler component 220 may consist of kaolin. According to yet other embodiments, the flame retardant filler component 220 may consist of talc. According to other embodiments, the flame retardant filler component 220 may consist of vermiculite. According to still other embodiments, the flame retardant filler component 220 may consist of any combination of wallastonite, mica, clay, kaolin, talc, or vermiculite.

According to still other embodiments, the flame retardant filler component 220 may be a filler of a particular alumina silicate material or magnesium silicate material. For example, the flame retardant filler component 220 may be a wallastonite filler. According to yet other embodiments, the flame retardant filler component 220 may be a mica filler. According to still other embodiments, the flame retardant filler component 220 may be a clay filler. According to other embodiments, the flame retardant filler component 220 may be a kaolin filler. According to yet other embodiments, the flame retardant filler component 220 may be a talc filler. According to other embodiments, the flame retardant filler component 220 may be a vermiculite filler. According to still other embodiments, the flame retardant filler component 220 may be a filler of any combination of wallastonite, mica, clay, kaolin, talc, or vermiculite.

According to still other embodiments, the flame retardant filler component 220 may be selected from a particular group of alkaline salt materials. For example, the flame retardant filler component 220 may be selected from a group consisting of sodium carbonate, potassium carbonate and any combination thereof.

According to still other embodiments, the flame retardant filler component 220 may include a particular alkaline salt material. For example, the flame retardant filler component 220 may include sodium carbonate. According to yet other embodiments, the flame retardant filler component 220 may include potassium carbonate. According to still other embodiments, the flame retardant filler component 220 may include any combination of sodium carbonate, or potassium carbonate.

According to still other embodiments, the flame retardant filler component 220 may consist of a particular alkaline salt material. For example, the flame retardant filler component 220 may consist of sodium carbonate. According to yet other embodiments, the flame retardant filler component 220 may consist of potassium carbonate. According to still other embodiments, the flame retardant filler component 220 may consist of any combination of sodium carbonate, or potassium carbonate.

According to still other embodiments, the flame retardant filler component 220 may be a particular alkaline salt material filler. For example, the flame retardant filler component 220 may be a sodium carbonate filler. According to yet other embodiments, the flame retardant filler component 220 may be a potassium carbonate filler. According to still other embodiments, the flame retardant filler component 220 may be filler of any combination of sodium carbonate, or potassium carbonate.

According to still other embodiments, the insulation filler component 230 may be selected from a particular group of materials. For example, the insulation filler component 230 may be selected from a group consisting of expanded perlite, unexpanded perlite, glass beads, vermiculite, expanded vermiculite, expanded glass, zeolite, aerogel, silica, porous silica, porous alumina and any combination thereof.

According to still other embodiments, the insulation filler component 230 may include a particular material. For example, the insulation filler component 230 may include expanded perlite. According to yet other embodiments, the insulation filler component 230 may include unexpanded perlite. According to yet other embodiments, the insulation filler component 230 may include glass beads. According to yet other embodiments, the insulation filler component 230 may include vermiculite. According to yet other embodiments, the insulation filler component 230 may include expanded vermiculite. According to yet other embodiments, the insulation filler component 230 may include expanded glass. According to yet other embodiments, the insulation filler component 230 may include zeolite. According to still other embodiments, the insulation filler component 230 may include aerogel. According to yet other embodiments, the insulation filler component 230 may include silica. According to yet other embodiments, the insulation filler component 230 may include porous silica. According to other embodiments, the insulation filler component 230 may include porous alumina. According to still other embodiments, the insulation filler component 230 may include any combination of expanded perlite, unexpanded perlite, glass beads, vermiculite, expanded vermiculite, expanded glass, zeolite, aerogel, silica, porous silica, or porous alumina.

According to still other embodiments, the insulation filler component 230 may consist of a particular material. For example, the insulation filler component 230 may consist of expanded perlite. According to yet other embodiments, the insulation filler component 230 may consist of unexpanded perlite. According to yet other embodiments, the insulation filler component 230 may consist of glass beads. According to yet other embodiments, the insulation filler component 230 may consist of vermiculite. According to yet other embodiments, the insulation filler component 230 may consist of expanded vermiculite. According to yet other embodiments, the insulation filler component 230 may consist of expanded glass. According to yet other embodiments, the insulation filler component 230 may consist of zeolite. According to still other embodiments, the insulation filler component 230 may consist of aerogel. According to yet other embodiments, the insulation filler component 230 may consist of silica. According to yet other embodiments, the insulation filler component 230 may consist of porous silica. According to other embodiments, the insulation filler component 230 may consist of porous alumina. According to still other embodiments, the insulation filler component 230 may consist of any combination of expanded perlite, unexpanded perlite, glass beads, vermiculite, expanded vermiculite, expanded glass, zeolite, aerogel, silica, porous silica, or porous alumina.

According to still other embodiments, the insulation filler component 230 may be a filler of a particular material. For example, the insulation filler component 230 may be an expanded perlite filler. According to yet other embodiments, the insulation filler component 230 may be an unexpanded perlite filler. According to yet other embodiments, the insulation filler component 230 may be a glass beads filler. According to yet other embodiments, the insulation filler component 230 may be a vermiculite filler. According to yet other embodiments, the insulation filler component 230 may be an expanded vermiculite filler. According to yet other embodiments, the insulation filler component 230 may be an expanded glass filler. According to yet other embodiments, the insulation filler component 230 may be a zeolite filler. According to still other embodiments, the insulation filler component 230 may be an aerogel filler. According to yet other embodiments, the insulation filler component 230 may be a silica filler. According to yet other embodiments, the insulation filler component 230 may be a porous silica filler. According to other embodiments, the insulation filler component 230 may be a porous alumina filler. According to still other embodiments, the insulation filler component 230 may be a filler of any combination of expanded perlite, unexpanded perlite, glass beads, vermiculite, expanded vermiculite, expanded glass, zeolite, aerogel, silica, porous silica, or porous alumina.

According to certain embodiments, the foam layer 205 may include a particular content of the silicone based matrix component 210. For example, the foam layer 205 may include a silicone based matrix component content of at least about 20 wt. % for a total weight of the foam layer, such as, at least about 25 wt. % or at least about 30 wt. % or at least about 35 wt. % or at least about 40 wt. % or at least about 45 wt. % or even at least about 50 wt. %. According to yet other embodiments, the foam layer 205 may include a silicone based matrix component content of not greater than about 85 wt. % for a total weight of the foam layer, such as, not greater than about 80 wt. % or not greater than about 75 wt. % or not greater than about 70 wt. % or even not greater than about 65 wt. %. It will be appreciated that the silicone based matrix component content of the foam layer 205 may be within a range between any of the values noted above. It will be further appreciated that the silicone based matrix component content of the foam layer 205 may be any value between any of the minimum and maximum values noted above.

According to certain embodiments, the thermal barrier composite 200 may include a particular content of the silicone based matrix component 210. For example, the thermal barrier composite 200 may include a silicone based matrix component content of at least about 20 wt. % for a total weight of the foam layer, such as, at least about 25 wt. % or at least about 30 wt. % or at least about 35 wt. % or at least about 40 wt. % or at least about 45 wt. % or even at least about 50 wt. %. According to yet other embodiments, the thermal barrier composite 200 may include a silicone based matrix component content of not greater than about 85 wt. % for a total weight of the foam layer, such as, not greater than about 80 wt. % or not greater than about 75 wt. % or not greater than about 70 wt. % or even not greater than about 65 wt. %. It will be appreciated that the silicone based matrix component content of the thermal barrier composite 200 may be within a range between any of the values noted above. It will be further appreciated that the silicone based matrix component content of the thermal barrier composite 200 may be any value between any of the minimum and maximum values noted above.

According to still other embodiments, the foam layer 205 may include a particular content of flame retardant filler component 220. For example, the foam layer 205 may include a flame retardant filler component content of at least about 1 wt. % for a total weight of the foam layer 205, such as, at least about 2 wt. % or at least about 3 wt. % or at least about 4 wt. % or at least about 5 wt. % or at least about 7 wt. % or at least about 10 wt. % or at least about 12 wt. % or even at least about 15.%. According to yet other embodiments, the foam layer 205 may include a flame retardant filler component content of not greater than about 35 wt. % for a total weight of the foam layer 205, such as, not greater than about 34 wt. % or not greater than about 33 wt. % or not greater than about 32 wt. % or not greater than about 31 wt. % or not greater than about 30 wt. % or not greater than about 28 wt. % or not greater than about 25 wt. % or not greater than about 23 wt. % or not great than about 20 wt. %. It will be appreciated that the flame retardant filler component content of the foam layer 205 may be within a range between any of the values noted above. It will be further appreciated that the flame retardant filler component content of the foam layer 205 may be any value between any of the minimum and maximum values noted above.

According to still other embodiments, the thermal barrier composite 200 may include a particular content of flame retardant filler component 220. For example, the thermal barrier composite 200 may include a flame retardant filler component content of at least about 1 wt. % for a total weight of the thermal barrier composite 200, such as, at least about 2 wt. % or at least about 3 wt. % or at least about 4 wt. % or at least about 5 wt. % or at least about 7 wt. % or at least about 10 wt. % or at least about 12 wt. % or even at least about 15.%. According to yet other embodiments, the thermal barrier composite 200 may include a flame retardant filler component content of not greater than about 35 wt. % for a total weight of the thermal barrier composite 200, such as, not greater than about 34 wt. % or not greater than about 33 wt. % or not greater than about 32 wt. % or not greater than about 31 wt. % or not greater than about 30 wt. % or not greater than about 28 wt. % or not greater than about 25 wt. % or not greater than about 23 wt. % or not great than about 20 wt. %. It will be appreciated that the flame retardant filler component content of the thermal barrier composite 200 may be within a range between any of the values noted above. It will be further appreciated that the flame retardant filler component content of the thermal barrier composite 200 may be any value between any of the minimum and maximum values noted above.

According to still other embodiments, the foam layer 205 may include a particular content of insulation filler component 220. For example, the foam layer 205 may include an insulation filler component content of at least about 1 wt. % for a total weight of the foam layer 205, such as, at least about 2 wt. % or at least about 3 wt. % or at least about 4 wt. % or at least about 5 wt. % or at least about 7 wt. % or at least about 10 wt. % or at least about 12 wt. % or even at least about 15.%. According to yet other embodiments, the foam layer 205 may include an insulation filler component content of not greater than about 25 wt. % for a total weight of the foam layer 205, such as, not greater than about 24 wt. % or not greater than about 23 wt. % or not greater than about 22 wt. % or not greater than about 21 wt. % or not greater than about 20 wt. % or not greater than about 19 wt. % or not greater than about 18 wt. % or not greater than about 17 wt. % or not great than about 16 wt. %. It will be appreciated that the insulation filler component content of the foam layer 205 may be within a range between any of the values noted above. It will be further appreciated that the insulation filler component content of the foam layer 205 may be any value between any of the minimum and maximum values noted above.

According to still other embodiments, the thermal barrier composite 200 may include a particular content of insulation filler component 220. For example, the thermal barrier composite 200 may include an insulation filler component content of at least about 1 wt. % for a total weight of the thermal barrier composite 200, such as, at least about 2 wt. % or at least about 3 wt. % or at least about 4 wt. % or at least about 5 wt. % or at least about 7 wt. % or at least about 10 wt. % or at least about 12 wt. % or even at least about 15 wt. %. According to yet other embodiments, the thermal barrier composite 200 may include an insulation filler component content of not greater than about 25 wt. % for a total weight of the thermal barrier composite 200, such as, not greater than about 24 wt. % or not greater than about 23 wt. % or not greater than about 22 wt. % or not greater than about 21 wt. % or not greater than about 20 wt. % or not greater than about 19 wt. % or not greater than about 18 wt. % or not greater than about 17 wt. % or not great than about 16 wt. %. It will be appreciated that the insulation filler component content of the thermal barrier composite 200 may be within a range between any of the values noted above. It will be further appreciated that the insulation filler component content of the thermal barrier composite 200 may be any value between any of the minimum and maximum values noted above.

According to certain embodiments, the foam layer 205 may have a particular flammability rating as measured according to ASTM D4986. In particular, the foam layer may have a HBF flammability rating as measured according to ASTM D4986.

According to certain embodiments, the foam layer 205 may have a particular flammability rating as measured according to ASTM D3801. In particular, the foam layer may have a V-0 flammability rating as measured according to ASTM D3801.

According to certain embodiments, the thermal barrier composite 200 may have a particular flammability rating as measured according to ASTM D4986. In particular, the foam layer may have a HBF flammability rating as measured according to ASTM D4986.

According to certain embodiments, the thermal barrier composite 200 may have a particular flammability rating as measured according to ASTM D3801. In particular, the foam layer may have a V-0 flammability rating as measured according to ASTM D3801.

According to yet other embodiments, the foam layer 205 may have a particular self-ignition time when exposed to a hot plate test at a temperature of 650° C. For purposes of embodiments described herein, the hot plate test is carried out by preparing a 1 inch by 1 inch specimen of the material, which is put on top of a hot plate. Then a thermal couple is fixed in a steel weight (1 inch in diameter, 2 inches in height) is put on top of the specimen to measure the cold side surface temperature. The temperature curve is recorded and the point, if any, of self-ignition is recorded. According to particular embodiments, the foam layer 205 may have a self ignition time of at least about 1 minute, such as, at least about 1.5 minutes or at least about 2 minutes or at least about 2.5 minutes or at least about 3 minutes or at least about 3.5 minutes or at least about 4.0 minutes or at least about 4.5 minutes or even at least about 5.0 minutes. It will be appreciated that the self ignition time of the foam layer 205 may be within a range between any of the values noted above. It will be further appreciated that the self-ignition time of the foam layer 205 may be any value between any of the values noted above.

According to yet other embodiments, the thermal barrier composite 200 may have a particular self-ignition time when exposed to a hot plate test at a temperature of 650° C. For purposes of embodiments described herein, the hot plate test is carried out by preparing a 1 inch by 1 inch specimen of the material, which is put on top of a hot plate. Then a thermal couple is fixed in a steel weight (1 inch in diameter, 2 inches in height) is put on top of the specimen to measure the cold side surface temperature. The temperature curve is recorded and the point, if any, of self-ignition is recorded. According to particular embodiments, the thermal barrier composite 200 may have a self ignition time of at least about 1 minute, such as, at least about 1.5 minutes or at least about 2 minutes or at least about 2.5 minutes or at least about 3 minutes or at least about 3.5 minutes or at least about 4.0 minutes or at least about 4.5 minutes or even at least about 5.0 minutes. It will be appreciated that the self ignition time of the thermal barrier composite 200 may be within a range between any of the values noted above. It will be further appreciated that the self-ignition time of the thermal barrier composite 200 may be any value between any of the values noted above.

According to still other embodiments, the foam layer 205 may have a particular cold-side temperature as measured at 5 minutes when a 3 mm thickness of the foam is exposed to a hot plate test at 650° C. For purposes of embodiments described herein, the hot plate test is carried out by preparing a 1 inch by 1 inch specimen of the material, which is put on top of a hot plate. Then a thermal couple is fixed in a steel weight (1 inch in diameter, 2 inches in height) is put on top of the specimen to measure the cold side surface temperature. According to certain embodiments, the foam layer 205 may have a cold side temperature of not greater than about 300° C., such as, not greater than about 275° C. or not greater than about 250° C. or not greater than about 225 or not greater than about 200° C. or not greater than about 175° C. or even not greater than about 150° C. According to still other embodiments, the foam layer 205 may have a cold side temperature of at least about 25° C. It will be appreciated that the cold side temperature of the foam layer 205 may be within a range between any of the values noted above. It will be further appreciated that the cold side temperature of the foam layer 205 may be any value between any of the values noted above.

According to yet other embodiments, the thermal barrier composite 200 may have a particular self-ignition time when exposed to a hot plate test at a temperature of 650° C. For purposes of embodiments described herein, the hot plate test is carried out by preparing a 1 inch by 1 inch specimen of the material, which is put on top of a hot plate. Then a thermal couple is fixed in a steel weight (1 inch in diameter, 2 inches in height) is put on top of the specimen to measure the cold side surface temperature. The temperature curve is recorded and the point, if any, of self-ignition is recorded. According to particular embodiments, the thermal barrier composite 200 may have a self ignition time of at least about 1 minute, such as, at least about 1.5 minutes or at least about 2 minutes or at least about 2.5 minutes or at least about 3 minutes or at least about 3.5 minutes or at least about 4.0 minutes or at least about 4.5 minutes or even at least about 5.0 minutes. It will be appreciated that the self ignition time of the thermal barrier composite 200 may be within a range between any of the values noted above. It will be further appreciated that the self-ignition time of the thermal barrier composite 200 may be any value between any of the values noted above.

According to yet other embodiments, the foam layer 205 may have a particular thickness. For example, the foam layer 205 may have a thickness of at least about 0.5 mm, such as, at least about 1.0 mm or at least about 1.5 mm or at least about 2.0 mm or at least about 2.5 mm or at least about 3.0 mm or at least about 3.5 mm or at least about 4.0 mm or at least about 4.5 mm or even at least about 5.0 mm. According to still other embodiments, the foam layer 205 may have a thickness of not greater than about 10 mm, such as, not greater than about 9.5 mm or not greater than about 9.0 mm or not greater than about 8.5 mm or not greater than about 8.0 mm or not greater than about 7.5 mm or not greater than about 7.0 mm or not greater than about 6.5 mm or even not greater than about 6.0 mm. It will be appreciated that the thickness of the foam layer 205 may be within a range between any of the minimum and maximum values noted above. It will be further appreciated that the thickness of the foam layer 205 may be any value between any of the minimum and maximum values noted above.

According to yet other embodiments, the thermal barrier composite 200 may have a particular thickness. For example, the thermal barrier composite 200 may have a thickness of at least about 0.5 mm, such as, at least about 1.0 mm or at least about 1.5 mm or at least about 2.0 mm or at least about 2.5 mm or at least about 3.0 mm or at least about 3.5 mm or at least about 4.0 mm or at least about 4.5 mm or even at least about 5.0 mm. According to still other embodiments, the thermal barrier composite 200 may have a thickness of not greater than about 10 mm, such as, not greater than about 9.5 mm or not greater than about 9.0 mm or not greater than about 8.5 mm or not greater than about 8.0 mm or not greater than about 7.5 mm or not greater than about 7.0 mm or not greater than about 6.5 mm or even not greater than about 6.0 mm. It will be appreciated that the thickness of the thermal barrier composite 200 may be within a range between any of the minimum and maximum values noted above. It will be further appreciated that the thickness of the thermal barrier composite 200 may be any value between any of the minimum and maximum values noted above.

According to yet other embodiments, the foam layer 205 may have a particular 25% strain compression rating. For purposes of embodiments described herein, the 25% strain compression rating is defined as the compression rating of a sample measure at a 25% strain and is determined by measuring the force-to-compress and compression-force-deflection of the sample at a 25% strain. Force-to-compress (FTC) is defined as the peak force (or stress) to compress the sample to a predetermined strain and compression-force-deflection (CFD) is defined as the plateau or relaxation force (or stress) retained by a sample when held at the desired strain (i.e., 25%). Measurements are made using a Texture Analyzer, which finds and records both FTC values and CFD values after a hold time of 60 seconds, a compression speed of 0.16 mm/s and a trigger force of 10 grams.

According to yet other embodiments, the thermal barrier composite 200 may have a particular 25% strain compression rating. For purposes of embodiments described herein, the 25% strain compression rating is defined as the compression rating of a sample measure at a 25% strain and is determined by measuring the force-to-compress and compression-force-deflection of the sample at a 25% strain. Force-to-compress (FTC) is defined as the peak force (or stress) to compress the sample to a predetermined strain and compression-force-deflection (CFD) is defined as the plateau or relaxation force (or stress) retained by a sample when held at the desired strain (i.e., 25%). Measurements are made using a Texture Analyzer, which finds and records both FTC values and CFD values after a hold time of 60 seconds, a compression speed of 0.16 mm/s and a trigger force of 10 grams.

According to certain embodiments, the foam layer 205 may have a 25% strain compression rating of not greater than about 500 kPa, such as, not greater than about 475 kPa or not greater than about 450 kPa or not greater than about 425 kPa or not greater than about 400 kPa or not greater than about 375 kPa or not greater than about 350 kPa or not greater than about 325 kPa or not greater than about 300 kPa or not greater than about 275 kPa or not greater than about 250 kPa or not greater than about 225 kPa or not greater than about 200 kPa or not greater than about 175 kPa or not greater than about 150 kPa or not greater than about 125 kPa or not greater than about 100 kPa. According to still other embodiments, the foam layer 205 may have a 25% strain compression rating of at least about 5 kPa, such as, at least about 10 kPa or at least about 15 kPa or at least about 20 kPa or at least about 25 kPa. It will be appreciated that the 25% strain compression rating of the foam layer 205 may be within a range between any of the minimum and maximum values noted above. It will be further appreciated that the 50% strain compression rating of the multilayer composite 100 may be any value between any of the minimum and maximum values noted above.

According to certain embodiments, the thermal barrier composite 200 may have a 25% strain compression rating of not greater than about 500 kPa, such as, not greater than about 475 kPa or not greater than about 450 kPa or not greater than about 425 kPa or not greater than about 400 kPa or not greater than about 375 kPa or not greater than about 350 kPa or not greater than about 325 kPa or not greater than about 300 kPa or not greater than about 275 kPa or not greater than about 250 kPa or not greater than about 225 kPa or not greater than about 200 kPa or not greater than about 175 kPa or not greater than about 150 kPa or not greater than about 125 kPa or not greater than about 100 kPa. According to still other embodiments, the thermal barrier composite 200 may have a 25% strain compression rating of at least about 5 kPa, such as, at least about 10 kPa or at least about 15 kPa or at least about 20 kPa or at least about 25 kPa. It will be appreciated that the 25% strain compression rating of the thermal barrier composite 200 may be within a range between any of the minimum and maximum values noted above. It will be further appreciated that the 50% strain compression rating of the multilayer composite 100 may be any value between any of the minimum and maximum values noted above.

According to yet other embodiments, the foam layer 205 may have a particular density. For purpose of embodiments described herein, the density of the foam layer 205 may be determined according to ASTM D1056. According to certain embodiments, the foam layer 205 may have a density of not greater than about 1200 kg/m^{3,} such as, not great than about 1175 kg/m³ or not greater than about 1150 kg/m³ or not greater than about 1125 kg/m³ or not greater than about 1100 kg/m³ or not greater than about 1050 kg/m³ or not greater than about 1000 kg/m³ or not greater than about 950 kg/m³ or not greater than about 900 kg/m³ or not greater than about 850 kg/m³ or not greater than about 800 kg/m³ or not greater than about 750 kg/m³ or not greater than about 700 kg/m³ or even not greater than about 650 kg/m³. According to yet other embodiments, the foam layer 205 may have a density of at least about 100 kg/m³, such as, at least about 120 kg/m³ or at least about 140 kg/m³ or at least about 160 kg/m³ or at least about 180 kg/m³ or at least about 200 kg/m³ or at least about 220 kg/m³ or even at least about 240 kg/m³. It will be appreciated that the density of the foam layer 205 may be within a range between any of the minimum and maximum values noted above. It will be further appreciated that the density of the foam layer 205 may be any value between any of the minimum and maximum values noted above.

According to yet other embodiments, the thermal barrier composite 200 may have a particular density. For purpose of embodiments described herein, the density of the thermal barrier composite 200 may be determined according to ASTM D1056. According to certain embodiments, the thermal barrier composite 200 may have a density of not greater than about 1200 kg/m³, such as, not great than about 1175 kg/m³ or not greater than about 1150 kg/m³ or not greater than about 1125 kg/m³ or not greater than about 1100 kg/m³ or not greater than about 1050 kg/m³ or not greater than about 1000 kg/m³ or not greater than about 950 kg/m³ or not greater than about 900 kg/m³ or not greater than about 850 kg/m³ or not greater than about 800 kg/m³ or not greater than about 750 kg/m³ or not greater than about 700 kg/m³ or even not greater than about 650 kg/m³. According to yet other embodiments, the thermal barrier composite 200 may have a density of at least about 100 kg/m³, such as, at least about 120 kg/m³ or at least about 140 kg/m³ or at least about 160 kg/m³ or at least about 180 kg/m³ or at least about 200 kg/m³ or at least about 220 kg/m³ or even at least about 240 kg/m³. It will be appreciated that the density of the thermal barrier composite 200 may be within a range between any of the minimum and maximum values noted above. It will be further appreciated that the density of the thermal barrier composite 200 may be any value between any of the minimum and maximum values noted above.

According to yet other embodiments, the foam layer 205 may have a particular thermal conductivity as measured according to ASTM C518. For example, the foam layer 205 may have a thermal conductivity of at least about 0.01 W/mK, such as, at least about 0.02 W/mK or at least about 0.03 W/mK or at least about 0.04 W/mK or even at least about 0.05 W/mK. According to still other embodiments, the foam layer 205 may have a thermal conductivity of not greater than about 0.15 W/mK, such as, not greater than about 0.14 W/mK or not greater than about 0.13 W/mK or not greater than about 0.12 W/mK or not greater than about 0.11 W/mK or not greater than about 0.10 W/mK or not greater than about 0.09 W/mK or not greater than about 0.08 W/mK or even not greater than about 0.07 W/mK. It will be appreciated that the thermal conductivity of the foam layer 205 may be within a range between any of the minimum and maximum values noted above. It will be further appreciated that the thermal conductivity of the foam layer 205 may be any value between any of the minimum and maximum values noted above.

According to yet other embodiments, the thermal barrier composite 200 may have a particular thermal conductivity as measured according to ASTM C518. For example, the thermal barrier composite 200 may have a thermal conductivity of at least about 0.01 W/mK, such as, at least about 0.02 W/mK or at least about 0.03 W/mK or at least about 0.04 W/mK or even at least about 0.05 W/mK. According to still other embodiments, the thermal barrier composite 200 may have a thermal conductivity of not greater than about 0.15 W/mK, such as, not greater than about 0.14 W/mK or not greater than about 0.13 W/mK or not greater than about 0.12 W/mK or not greater than about 0.11 W/mK or not greater than about 0.10 W/mK or not greater than about 0.09 W/mK or not greater than about 0.08 W/mK or even not greater than about 0.07 W/mK. It will be appreciated that the thermal conductivity of the thermal barrier composite 200 may be within a range between any of the minimum and maximum values noted above. It will be further appreciated that the thermal conductivity of the thermal barrier composite 200 may be any value between any of the minimum and maximum values noted above.

According to certain embodiments, the thermal barrier composite described herein may be formed according to any acceptable forming process for a thermal barrier composite. According to a particular embodiment, the thermal barrier composite may be formed using a lamination process where the porous foam and barrier layer are laminated using a transfer adhesive such as, for example, a silicon adhesive, a rubber adhesive, an acrylic adhesive, a phenolic adhesive, a polyurethane based adhesive or any combination thereof. According to still other embodiments, the thermal barrier composite may be formed using a lamination process with a porous foam and a coated barrier layer, where the coating on the barrier layer is an adhesive, such as, a silicon adhesive, a rubber adhesive, an acrylic adhesive, a phenolic adhesive, a polyurethane based adhesive or any combination thereof. According to still other embodiments, the thermal barrier composite may be formed using a direct cast forming process, wherein the foam is directly cast onto the barrier films or between the barrier films.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the embodiments as listed below.

Embodiment 1. A foam layer comprising: a silicone based matrix component, a flame retardant filler component, and an insulation filler component, wherein the foam layer comprises a thickness of at least about 0.5 mm to and no greater than about 10 mm, wherein the foam layer comprises a 25% strain compression rating of at least about 5 kPa and not greater than about 500 kPa, and wherein the foam layer comprises a HBF flammability rating as measured according to ASTM D4986.

Embodiment 2. A foam layer comprising: a silicone based matrix component, a flame retardant filler component, and an insulation filler component, wherein the foam layer comprises a thickness of at least about 0.5 mm to and no greater than about 10 mm, wherein the foam layer comprises a 25% strain compression rating of at least about 5 kPa and not greater than about 500 kPa, a compression set rating of no greater than 25%, and wherein the foam layer comprises a self ignition time of at least about 1 minute when exposed to a hotplate test at 650° C.

Embodiment 3. A foam layer comprising: a silicone based matrix component, a flame retardant filler component, and an insulation filler component, wherein the flame retardant filler component comprises a filler selected from the group consisting of metal hydrates, borate compounds, platinum compounds, transition metal oxides, metal carbonates, calcium silicates, aluminum silicates, magnesium silicates, glass frits, alkaline salts, vermiculites and any combination thereof, wherein the insulation filler component comprises a filler selected from the group consisting of expanded perlite, unexpanded perlite, glass beads, vermiculite, expanded vermiculite, expanded glass, zeolite, aerogel, silica, porous silica, porous alumina and any combination thereof, wherein the foam layer comprises a 25% strain compression rating of at least about 5 kPa and not greater than about 500 kPa, a compression set rating of no greater than 25%, and wherein the foam layer comprises a thickness of at least about 0.5 mm to and no greater than about 10 mm.

Embodiment 4. The foam layer of any one of embodiments 1, 2, and 3, wherein the silicone based matrix component comprises platinum catalyzed addition cured silicone foam, peroxide cured silicone foam, tin catalyzed silicone foam and any combination thereof.

Embodiment 5. The foam layer of any one of embodiments 1 and 2, wherein the flame retardant filler component comprises a filler selected from a group consisting of metal hydrates, borate compounds, platinum compounds, transition metal oxides, metal carbonates, calcium silicates, aluminum silicates, magnesium silicates, glass frits, alkaline salts, vermiculites and any combination thereof.

Embodiment 6. The foam layer of any one of embodiments 1, 2, and 3, wherein the flame retardant filler component comprises a filler selected from a group consisting of aluminum trihydrate, magnesium dihydroxides, Boehmite, calcium hydroxide, Huntite, gypsum, hydromagnesite and any combination thereof.

Embodiment 7. The foam layer of any one of embodiments 1, 2, and 3, wherein the flame retardant filler component comprises a filler selected from a group consisting of zinc borate, calcium borate, sodium borate, potassium borate, lithium borate and any combination thereof.

Embodiment 8. The foam layer of any one of embodiments 1, 2, and 3, wherein the flame retardant filler component comprises a filler selected from a group consisting of platinum-1,3-divinyl-1,1,3,3-tetramethyldisiloxane, hexachloroplatinic acid and any combination thereof.

Embodiment 9. The foam layer of any one of embodiments 1, 2, and 3, wherein the flame retardant filler component comprises a filler selected from a group consisting of iron oxide, cerium oxide, titanium oxide, zinc oxide and any combination thereof.

Embodiment 10. The foam layer of any one of embodiments 1, 2, and 3, wherein the flame retardant filler component comprises a filler selected from a group consisting of Huntite, calcium carbonate and any combination thereof.

Embodiment 11. The foam layer of any one of embodiments 1, 2, and 3, wherein the flame retardant filler component comprises a filler selected from a group consisting of a natural mixture of hydromagnesite and Huntite, synthetic magnesium carbonate hydroxide pentahydrate and any combination thereof.

Embodiment 12. The foam layer of any one of embodiments 1, 2, and 3, wherein the flame retardant filler component comprises a filler selected from a group consisting of wallastonite, mica, clay, kaolin, talc, vermiculite and any combination thereof.

Embodiment 13. The foam layer of any one of embodiments 1, 2, and 3, wherein the flame retardant filler component comprises a filler selected from a group consisting of sodium carbonate, potassium carbonate and any combination thereof.

Embodiment 14. The foam layer of any one of embodiments 1 and 2, wherein the insulation filler component comprises a filler selected from the group consisting of expanded perlite, unexpanded perlite, glass beads, vermiculite, expanded vermiculite, expanded glass, zeolite, aerogel, silica, porous silica, porous alumina and any combination thereof.

Embodiment 15. The foam layer of any one of embodiments 1, 2, 3, 4, 5, and 14, wherein the foam layer comprises a silicone based matrix component content of at least about 20 wt. % for a total weight of the foam layer.

Embodiment 16. The foam layer of any one of embodiments 1, 2, 3, 4, 5, and 14, wherein the foam layer comprises a silicone based matrix component content of not greater than about 85 wt. % for a total weight of the foam layer.

Embodiment 17. The foam layer of any one of embodiments 1, 2, 3, 4, 5, and 14, wherein the foam layer comprises a flame retardant filler component content of at least about 1 wt. % for a total weight of the foam layer.

Embodiment 18. The foam layer of any one of embodiments 1, 2, 3, 4, 5, and 14, wherein the foam layer comprises a flame retardant filler component of not greater than about 35 wt. % for a total weight of the foam layer.

Embodiment 19. The foam layer of any one of embodiments 1, 2, 3, 4, 5, and 14, wherein the foam layer comprises an insulation filler component of not greater than about 25 wt. % for a total weight of the foam layer.

Embodiment 20. The foam layer of any one of embodiments 1, 2, 3, 4, 5, and 14, wherein the foam layer comprises an insulation filler component content of at least about 1 wt. % for a total weight of the foam layer.

Embodiment 21. The foam layer of any one of embodiments 2 and 3, wherein the foam layer comprises a HBF flammability rating as measured according to ASTM D4986.

Embodiment 22. The foam layer of any one of embodiments 1 and 3, wherein the foam layer comprises a self ignition time of at least about 1 minutes when exposed to a hotplate test at 650° C.

Embodiment 23. The foam layer of any one of embodiments 1, 2, and 3, wherein the foam layer comprises a cold side temperature of not greater than about 300° C. as measured at 5 minutes when a 3 mm foam is exposed to a hotplate test at 650° C.

Embodiment 24. The foam layer of any one of embodiments 1, 2, and 3, wherein the foam layer comprises a cold side temperature of at least about 25° C. as measured at 5 minutes when exposed to a hotplate test at 650° C.

Embodiment 25. The foam layer of any one of embodiments 1, 2, and 3, wherein the foam layer comprises a thickness of at least about 0.5 mm.

Embodiment 26. The foam layer of any one of embodiments 1, 2, and 3, wherein the foam layer comprises a thickness of not greater than about 10 mm.

Embodiment 27. The foam layer of any one of embodiments 1, 2, and 3, wherein the foam layer comprises a 25% strain compression rating of at least about 5 kPa.

Embodiment 28. The foam layer of any one of embodiments 1, 2, and 3, wherein the foam layer comprises a 25% strain compression rating of not greater than about 500 kPa.

Embodiment 29. The foam layer of any one of embodiments 1, 2, and 3, wherein the foam layer comprises a density of not greater than about 1200 kg/m³.

Embodiment 30. The foam layer of any one of embodiments 1, 2, and 3, wherein the foam layer comprises wherein the foam layer comprises a density of at least about 100 kg/m³.

Embodiment 31. The foam layer of any one of embodiments 1, 2, and 3, wherein the foam layer comprises a thermal conductivity of at least about 0.01 W/mK.

Embodiment 32. The foam layer of any one of embodiments 1, 2, and 3, wherein the foam layer comprises a thermal conductivity of not greater than about 0.15 W/mK.

Embodiment 33. A thermal barrier composite comprising a foam layer, wherein the foam layer comprises: a silicone based matrix component, a flame retardant filler component, and an insulation filler component, wherein the thermal barrier composite comprises a thickness of at least about 0.5 mm to and no greater than about 10 mm, wherein the thermal barrier composite comprises a 25% strain compression rating of at least about 5 kPa and not greater than about 500 kPa, and wherein the thermal barrier composite comprises a HBF flammability rating as measured according to ASTM D4986.

Embodiment 34. A thermal barrier composite comprising a foam layer, wherein the foam layer comprises: a silicone based matrix component, a flame retardant filler component, and an insulation filler component, wherein the thermal barrier composite comprises a thickness of at least about 0.5 mm to and no greater than about 10 mm, wherein the thermal barrier composite comprises a 25% strain compression rating of at least about 5 kPa and not greater than about 500 kPa, a compression set rating of no greater than 25%, and wherein the thermal barrier composite comprises a self ignition time of at least about 1 minute when exposed to a hotplate test at 650° C.

Embodiment 35. A thermal barrier composite comprising a foam layer, wherein the foam layer comprises: a silicone based matrix component, a flame retardant filler component, and an insulation filler component, wherein the flame retardant filler component comprises a filler selected from the group consisting of metal hydrates, borate compounds, platinum compounds, transition metal oxides, metal carbonates, calcium silicates, aluminum silicates, magnesium silicates, glass frits, alkaline salts, vermiculites and any combination thereof, wherein the insulation filler component comprises a filler selected from the group consisting of expanded perlite, unexpanded perlite, glass beads, vermiculite, expanded vermiculite, expanded glass, zeolite, aerogel, silica, porous silica, or porous alumina, wherein the thermal barrier composite comprises 25% strain compression rating of at least about 5 kPa and not greater than about 500 kPa, a compression set rating of no greater than 25%, and wherein the thermal barrier composite comprises a thickness of at least about 0.5 mm to and no greater than about 10 mm.

Embodiment 36. The thermal barrier composite of any one of embodiments 33, 34, and 35, wherein the silicone based matrix component comprises addition platinum catalyzed addition cured silicone foam, peroxide cured silicone foam, tin catalyzed silicone foam.

Embodiment 37. The thermal barrier composite of any one of embodiments 33 and 34, wherein the flame retardant filler component comprises a filler selected from a group consisting of metal hydrates, borate compounds, platinum compounds, transition metal oxides, metal carbonates, calcium silicates, aluminum silicates, magnesium silicates, glass frits, alkaline salts, vermiculites and any combination thereof.

Embodiment 38. The thermal barrier composite of any one of embodiments 33, 34, and 35, wherein the flame retardant filler component comprises a filler selected from a group consisting of aluminum trihydrate, magnesium dihydroxides, Boehmite, calcium hydroxide, Huntite, gypsum, hydromagnesite.

Embodiment 39. The thermal barrier composite of any one of embodiments 33, 34, and 35, wherein the flame retardant filler component comprises a filler selected from a group consisting of zinc borate, calcium borate, sodium borate, potassium borate, lithium borate.

Embodiment 40. The thermal barrier composite of any one of embodiments 33, 34, and 35, wherein the flame retardant filler component comprises a filler selected from a group consisting of platinum-1,3-divinyl-1,1,3,3-tetramethyldisiloxane, hexachloroplatinic acid.

Embodiment 41. The thermal barrier composite of any one of embodiments 33, 34, and 35, wherein the flame retardant filler component comprises a filler selected from a group consisting of iron oxide, cerium oxide, titanium oxide, zinc oxide.

Embodiment 42. The thermal barrier composite of any one of embodiments 33, 34, and 35, wherein the flame retardant filler component comprises a filler selected from a group consisting of Huntite, calcium carbonate.

Embodiment 43. The thermal barrier composite of any one of embodiments 33, 34, and 35, wherein the flame retardant filler component comprises a filler selected from a group consisting of a natural mixture of hydromagnesite and Huntite, synthetic magnesium carbonate hydroxide pentahydrate.

Embodiment 44. The thermal barrier composite of any one of embodiments 33, 34, and 35, wherein the flame retardant filler component comprises a filler selected from a group consisting of wallastonite, mica, clay, kaolin, talc, vermiculite.

Embodiment 45. The thermal barrier composite of any one of embodiments 33, 34, and 35, wherein the flame retardant filler component comprises a filler selected from a group consisting of sodium carbonate, potassium carbonate.

Embodiment 46. The thermal barrier composite of any one of embodiments 33 and 34, wherein the insulation filler component comprises a filler selected from the group consisting of expanded perlite, unexpanded perlite, glass beads, vermiculite, expanded vermiculite, expanded glass, zeolite, aerogel, silica, porous silica, or porous alumina.

Embodiment 47. The thermal barrier composite of any one of embodiments 33, 34, and 35, wherein the thermal barrier composite comprises a silicone based matrix component content of at least about 20 wt. % for a total weight of the thermal barrier composite.

Embodiment 48. The thermal barrier composite of any one of embodiments 33, 34, and 35, wherein the thermal barrier composite comprises a silicone based matrix component content of not greater than about 85 wt. % for a total weight of the thermal barrier composite.

Embodiment 49. The thermal barrier composite of any one of embodiments 33, 34, and 35, wherein the thermal barrier composite comprises a flame retardant filler component content of at least about 1 wt. % for a total weight of the thermal barrier composite.

Embodiment 50. The thermal barrier composite of any one of embodiments 33, 34, and 35, wherein the thermal barrier composite comprises a flame retardant filler component of not greater than about 35 wt. % for a total weight of the thermal barrier composite.

Embodiment 51. The thermal barrier composite of any one of embodiments 33, 34, and 35, wherein the thermal barrier composite comprises an insulation filler component of not greater than about 25 wt. % for a total weight of the thermal barrier composite.

Embodiment 52. The thermal barrier composite of any one of embodiments 33, 34, and 35, wherein the thermal barrier composite comprises an insulation filler component content of at least about 1 wt. % for a total weight of the thermal barrier composite.

Embodiment 53. The thermal barrier composite of any one of embodiments 34 and 35, wherein the thermal barrier composite comprises a HBF flammability rating as measured according to ASTM D4986.

Embodiment 54. The thermal barrier composite of any one of embodiments 33 and 35, wherein the thermal barrier composite comprises a self ignition time of at least about 1 minutes when exposed to a hotplate test at 650° C.

Embodiment 55. The thermal barrier composite of any one of embodiments 33, 34, and 35, wherein the thermal barrier composite comprises a cold side temperature of not greater than about 300° C. as measured at 5 minutes when a 3 mm foam is exposed to a hotplate test at 650° C.

Embodiment 56. The thermal barrier composite of any one of embodiments 33, 34, and 35, wherein the thermal barrier composite comprises a cold side temperature of at least about 25° C. as measured at 5 minutes when exposed to a hotplate test at 650° C.

Embodiment 57. The thermal barrier composite of any one of embodiments 33, 34, and 35, wherein the thermal barrier composite comprises a thickness of at least about 0.5 mm.

Embodiment 58. The thermal barrier composite of any one of embodiments 33, 34, and 35, wherein the thermal barrier composite comprises a thickness of not greater than about 10 mm.

Embodiment 59. The thermal barrier composite of any one of embodiments 33, 34, and 35, wherein the thermal barrier composite comprises 25% strain compression rating of at least about 5 kPa.

Embodiment 60. The thermal barrier composite of any one of embodiments 33, 34, and 35, wherein the thermal barrier composite comprises a 25% strain compression rating of not greater than about 500 kPa.

Embodiment 61. The thermal barrier composite of any one of embodiments 33, 34, and 35, wherein the thermal barrier composite comprises a density of not greater than about 1200 kg/m³.

Embodiment 62. The thermal barrier composite of any one of embodiments 33, 34, and 35, wherein the thermal barrier composite comprises wherein the thermal barrier composite comprises a density of at least about 100 kg/m³.

Embodiment 63. The thermal barrier composite of any one of embodiments 33, 34, and 35, wherein the thermal barrier composite comprises a thermal conductivity of at least about 0.01 W/mK.

Embodiment 64. The thermal barrier composite of any one of embodiments 33, 34, and 35, wherein the thermal barrier composite comprises a thermal conductivity of not greater than about 0.15 W/mK.

### EXAMPLES

The concepts described herein will be further described in the following Examples, which do not limit the scope of the invention described in the claims.

### Example 1

Three sample foam layers S1, S2 and S3 were formed according to embodiments described herein. Three comparative sample foam layers CS1, CS2 and CS3 were formed for comparison to the sample foam layer S1, S2 and S3. The composition of each sample foam layer S1, S2 and S3 and of each comparative sample foam layer CS1, CS2 and CS3 is summarized in table 1 below.

TABLE 1
Foam Layer Composition

| | | Foam Layer Composition | | | | |
|---|---|---|---|---|---|---|
| | | (wt. % for a total weight of the foam layer) | | | | |
| | Foam | Silicone | Flame | | | |
| | Layer | Based | Retardant | Insulation Filler Component | | |
| | Thickness | Matrix | Filler | Expanded | | |
| Sample | (mm) | Component | Component | Perlite | Alumina | Silica |
| S1 | 2.6 | 66 | 17 | 17 | 0 | 0 |
| S2 | 2.3 | 50 | 12 | 0 | 38 | 0 |
| S3 | 2.5 | 57 | 14 | 0 | 0 | 29 |
| CS1 | 3.1 | 80 | 20 | 0 | 0 | 0 |
| CS2 | | 80 | 0 | 20 | 0 | 0 |
| CS3 | | 57 | 0 | 0 | 43 | 0 |

The performance ratings (i.e. the flame resistance rating, self-ignition time and cold-side temperature) of the sample foam layers S1-S3, and the comparative sample foam layers CS1-CS3 are summarized in Table 2 below. It will be appreciated that the flame resistance rating is based on the samples performance in a UL94 V0 test, the self-ignition time is measured in a 650 ° C. hot plate test as described herein and the cold-side temperature is measured in a 650° C. hot plate test as described herein.

TABLE 2
Foam Layer Performance

| | | | | Cold-Side |
|---|---|---|---|---|
| | Flame Resistance | Self-Ignition | | Temperature at 5 |
| | Rating | Time in 650° C. | | min in 650° C. |
| Sample | (UL94 V0 - Y/N) | Hot Plate Test | | Hotplate Test |
| S1 | Y | >5 | min | 226° C. |
| S2 | Y | >5 | min | 316° C. |
| S3 | Y | >5 | min | 279° C. |
| CS1 | Y | 2 | seconds | 247° C. |
| CS2 | — | 10 | seconds | — |
| CS3 | — | 2 | seconds | — |

Without wishing to be tied to any particular theory, it is thought that there is a synergistic effect between the use of a flame retardant filler in combination with an insulation filler in the silicone based foam systems of S1, S2, and S3. This synergistic effect is clearly demonstrated through the performance of the samples outlined above. Specifically, the sample foam layers S1, S2, and S3 showed particular improvement in their flame resistance rating, self-ignition time and cold-side temperature when compared to the same parameters measured in the comparative sample foam layers CS1, CS2 and CS3.

Note that not all of the activities described above in the general description or the examples are required, that a portion of a specific activity may not be required, and that one or more further activities may be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. A foam layer comprising:
a silicone based matrix component,
a flame retardant filler component, and
an insulation filler component,
wherein the foam layer comprises a thickness of at least about 0.5 mm to and no greater than about 10 mm,
wherein the foam layer comprises a 25% strain compression rating of at least about 5 kPa and not greater than about 500 kPa, and
wherein the foam layer comprises a HBF flammability rating as measured according to ASTM D4986.

2. The foam layer of claim 1, wherein the silicone based matrix component comprises platinum catalyzed addition cured silicone foam, peroxide cured silicone foam, tin catalyzed silicone foam and any combination thereof.

3. The foam layer of claim 1, wherein the flame retardant filler component comprises a filler selected from a group consisting of metal hydrates, borate compounds, platinum compounds, transition metal oxides, metal carbonates, calcium silicates, aluminum silicates, magnesium silicates, glass frits, alkaline salts, vermiculites and any combination thereof.

4. The foam layer of claim 1, wherein the flame retardant filler component comprises a filler selected from a group consisting of aluminum trihydrate, magnesium dihydroxides, boehmite, calcium hydroxide, Huntite, gypsum, hydromagnesite and any combination thereof.

5. The foam layer of claim 1, wherein the flame retardant filler component comprises a filler selected from a group consisting of zinc borate, calcium borate, sodium borate, potassium borate, lithium borate and any combination thereof.

6. The foam layer of claim 1, wherein the flame retardant filler component comprises a filler selected from a group consisting of platinum-1,3-divinyl-1,1,3,3-tetramethyldisiloxane, hexachloroplatinic acid and any combination thereof.

7. The foam layer of claim 1, wherein the flame retardant filler component comprises a filler selected from a group consisting of iron oxide, cerium oxide, titanium oxide, zinc oxide and any combination thereof.

8. The foam layer of claim 1, wherein the flame retardant filler component comprises a filler selected from a group consisting of Huntite, calcium carbonate and any combination thereof.

9. The foam layer of claim 1, wherein the flame retardant filler component comprises a filler selected from a group consisting of a natural mixture of hydromagnesite and Huntite, synthetic magnesium carbonate hydroxide pentahydrate and any combination thereof.

10. The foam layer of claim 1, wherein the flame retardant filler component comprises a filler selected from a group consisting of wallastonite, mica, clay, kaolin, talc, vermiculite and any combination thereof.

11. The foam layer of claim 1, wherein the flame retardant filler component comprises a filler selected from a group consisting of sodium carbonate, potassium carbonate and any combination thereof.

12. The foam layer of claim 1, wherein the insulation filler component comprises a filler selected from the group consisting of expanded perlite, unexpanded perlite, glass beads, vermiculite, expanded vermiculite, expanded glass, zeolite, aerogel, silica, porous silica, porous alumina and any combination thereof.

13. A foam layer comprising:
a silicone based matrix component,
a flame retardant filler component, and
an insulation filler component,
wherein the foam layer comprises a thickness of at least about 0.5 mm to and no greater than about 10 mm,
wherein the foam layer comprises a 25% strain compression rating of at least about 5 kPa and not greater than about 500 kPa, a compression set rating of no greater than 25%, and
wherein the foam layer comprises a self ignition time of at least about 1 minute when exposed to a hotplate test at 650° C.

14. The foam layer of claim 13, wherein the silicone based matrix component comprises platinum catalyzed addition cured silicone foam, peroxide cured silicone foam, tin catalyzed silicone foam and any combination thereof.

15. The foam layer of claim 13, wherein the flame retardant filler component comprises a filler selected from a group consisting of metal hydrates, borate compounds, platinum compounds, transition metal oxides, metal carbonates, calcium silicates, aluminum silicates, magnesium silicates, glass frits, alkaline salts, vermiculites and any combination thereof.

16. The foam layer of claim 13, wherein the flame retardant filler component comprises a filler selected from a group consisting of aluminum trihydrate, magnesium dihydroxides, boehmite, calcium hydroxide, Huntite, gypsum, hydromagnesite and any combination thereof.

17. The foam layer of claim 13, wherein the flame retardant filler component comprises a filler selected from a group consisting of zinc borate, calcium borate, sodium borate, potassium borate, lithium borate and any combination thereof.

18. The foam layer of claim 13, wherein the flame retardant filler component comprises a filler selected from a group consisting of platinum-1,3-divinyl-1,1,3,3-tetramethyldisiloxane, hexachloroplatinic acid and any combination thereof.

19. A thermal barrier composite comprising a foam layer, wherein the foam layer comprises:
a silicone based matrix component,
a flame retardant filler component, and
an insulation filler component,
wherein the thermal barrier composite comprises a thickness of at least about 0.5 mm to and no greater than about 10 mm,
wherein the thermal barrier composite comprises a 25% strain compression rating of at least about 5 kPa and not greater than about 500 kPa, and
wherein the thermal barrier composite comprises a HBF flammability rating as measured according to ASTM D4986.

20. The thermal barrier composite of claim 19, wherein the flame retardant filler component comprises a filler selected from a group consisting of metal hydrates, borate compounds, platinum compounds, transition metal oxides, metal carbonates, calcium silicates, aluminum silicates, magnesium silicates, glass frits, alkaline salts, vermiculites and any combination thereof.
